(19) United States
(12) Patent Application Publication
(10) Pub. No.: US 2024/0213437 A1
(43) Pub. Date: Jun. 27, 2024

(54) High Solid Content Battery Ink for Printed Batteries and Methods of Making

(71) Applicant: Northeastern University, Boston, MA (US)

(72) Inventors: Hongli Zhu, Arlington, MA (US); Ying Wang, Boston, MA (US)

(21) Appl. No.: 18/545,285

(22) Filed: Dec. 19, 2023

Related U.S. Application Data
(60) Provisional application No. 63/434,715, filed on Dec. 22, 2022.

(51) Int. Cl. H01M 4/04; H01M 4/505; H01M 4/525; H01M 4/62

(52) U.S. Cl. CPC H01M 4/0414; H01M 4/505; H01M 4/525; H01M 4/623; H01M 4/625; H01M 2220/20; H01M 2220/30

(57) ABSTRACT

A screen-printable electrode battery ink is described comprising a slurry of an active ingredient, conductive additive, a binder, and a solvent, the slurry having a solids content from about 40% by weight to about 70% by weight that is uniformly distributed in the solvent, wherein the ink has a thixotropic recovery rate from about 30 seconds to about 90 seconds, and wherein the binder has untwisted molecular chains. Methods for making the screen-printable electrode battery ink are also described. The screen-printable electrode battery inks can be used to screen print electrodes, for use in fast-charging battery. Fast-charging batteries can be incorporated into electronic devices, such as electric vehicles.

### RELATED APPLICATION

This application claims the benefit of U.S. Provisional Application No. 63/434,715, filed on Dec. 22, 2022. The entire teachings of the above application are incorporated herein by reference.

### GOVERNMENT FUNDING

This invention was made with government support under Grant Number DE-EE0009111 awarded by U.S. Department of Energy. The government has certain rights in the invention.

### BACKGROUND

Ink with high solid content is necessary for the industrialization of screen-printed batteries because of high printing mass loading per printing layer and less solvent required for ink fabrication. However, the high solid content can negatively impair the rheological properties and screen printability of inks. To date, most screen-printable Li-ion cathode inks have a solid content below 40 weight percent (wt. %). This solid content is much lower than that of electrode slurries used for traditional bar-coating manufacturing processes (e.g., greater than 55 wt. % solid content).

### SUMMARY

A screen-printable electrode battery ink is described comprising a slurry of an active ingredient, conductive additive, a binder, and a solvent, the slurry having a solids content from about 40% by weight to about 70% by weight that is uniformly distributed in the solvent, wherein the ink has a thixotropic recovery rate from about 30 seconds to about 90 seconds, and wherein the binder has untwisted molecular chains. Methods for making the screen-printable electrode battery ink are also described. The screen-printable electrode battery inks can be used to screen print electrodes, for use in fast-charging batteries, flexible printed and thin film batteries, and wearable electronic devices. Fast-charging batteries can be incorporated into electronic devices, such as electric vehicles. The inks and method can dramatically improve the ink screen printability of printed electrodes having better electrochemical properties.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments. The drawings are not necessarily to scale, emphasis instead being placed upon illustrating embodiments.

FIG. 1A shows the relationship between the screen printability of inks with twisted (left panel) and untwisted molecular chains (right panel), respectively. FIG. 1. Schematic of the effects of twisted (left panel) and untwisted (right panel) molecular chains in the binder on the screen printability of ink.

FIGS. 1B-1E are schematics of the micromorphological ink structure during the two-step approach ink preparation process of the disclosure.

FIGS. 2A-2F show the rheological properties of the three kinds of prepared inks. FIG. 2A illustrates viscosity as a function of shear rate. FIG. 2B illustrates shear stress as a function of shear rate. FIG. 2C illustrates the three-step thixotropy test. FIGS. 2D-2F show optical images of the M1 (FIG. 2D), M2 (FIG. 2E), and M3 (FIG. 2F) inks along with one-layer printed patterns before and after drying; the scale bars are 4 mm in length.

FIGS. 3A-3C show SEM images of printed electrodes. Top-view low-magnification images of one-layer printed (FIG. 3A, panel 1) M1, (FIG. 3B, panel 1) M2, and (FIG. 3C, panel 1) M3 electrodes are shown. Top-view high-magnification images of one-layer printed (FIG. 3A, panel 2) M1, (FIG. 3B, panel 2) M2, and (FIG. 3C, panel 2) M3 electrodes are shown. Cross-sectional images of (FIG. 3A, panel 3) M1, (FIG. 3B, panel 3) M2, and (FIG. 3C, panel 3) M3 electrodes are shown.

FIGS. 4A-4L illustrate distributions of NMC 622, super P, and PVDF in one-layer printed M1 and M3 electrodes were revealed by XCT. Reconstructed 2D images of the screen-printed (FIG. 4A) M1, (FIG. 4E) M2, and (FIG. 4I) M3 electrodes are shown. 3D segmented images of the (FIGS. 4B to 4D) M1 electrode, (FIGS. 4F to 4H) M2 electrode, and (FIGS. 4J to 4L) M3 electrode with the element distributions.

FIGS. 5A-5E are graphic illustrations of electrochemical performance of screen-printed electrodes. FIG. 5A are current/voltage (CV) curves of the as-printed electrodes. FIG. 5B illustrates galvanostatic charge and discharge curves of the M3 electrode at 0.1 C. FIG. 5C are Nyquist plots of screen-printed M1, M2, and M3 electrodes. FIG. 5D show rate performance of screen-printed M1, M2, and M3 electrodes. FIG. 5E show long-term cycling performance of screen-printed M1, M2, and M3 electrodes.

FIGS. 6A-6D are graphs and an illustration of the development of the proposed ink preparation process. Rheological properties of M3 inks were prepared with various 1st sol-2nd sol values. FIG. 6A shows viscosity as a function of shear rate and FIG. 6B shows three-step thixotropy test (0.1, 200, and 0.1 s-1 shear rates were applied in three intervals, 0-90 s, 90-100 s, and 100-200 s). FIG. 6C shows the rate performance of M3 electrodes fabricated with different solvent addition ratios. FIG. 6D is a schematic of the effect of the solvent addition ratio on the material distribution during mixing of inks with the same solid content fabricated by the two-step approach of the disclosure.

FIGS. 7A-7I. Equilibrium configurations for the (FIG. 7A) M1, (FIG. 7B) M2, and (FIG. 7C) M3 systems. Snapshots of the shear behavior at a shear rate of 20 s-1 for the (FIG. 7D) M1, (FIG. 7E) M2, and (FIG. 7F) M3 systems with increasing simulation time from 0 (left) to 0.553 s (right). Radial distribution functions (RDFs) after shear application for (FIG. 7G) the different types of particles and (FIG. 7H) the same types of particles for the three methods. (FIG. 7I) The viscosity of inks prepared by the three methods as a function of shear rate.

FIGS. 8A-8C illustrate a detailed ink preparation process with optical images of each mixing step for the M1 (FIG. 8A), M2 (FIG. 8B), and M3 (FIG. 8C) inks.

FIGS. 9A and 9B illustrate the rheological properties of M1 inks with solid contents from 50% to 65%: (FIG. 9A) viscosity as a function of shear rate and (FIG. 9B) three-step thixotropy test.

FIG. 10 shows digital images and printability of M1 inks with solid contents from 65% to 50%. The scale bars are 5 mm in length.

FIGS. 11A and 11B illustrate rheological properties of M2 inks with solid contents from 50% to 60%. FIG. 11A shows viscosity as a function of shear rate and FIG. 11B shows the three-step thixotropy test.

FIG. 12 are digital images and printability of M2 inks with solid contents from 60% to 50%. The scale bars are 5 mm in length.

FIGS. 13A-13F, each comprising three panels, illustrate rheological properties of (FIG. 13A) T-inks and (FIG. 13B) U-inks. The solid content of these inks is 60%. Panel 1: viscosity as a function of shear rate; panel 2: stress as a function of shear rate; and panel 3: three-step thixotropy test (0.1, 200, and 0.1 s-1 shear rates were set in three intervals, 0-90 s, 90-100 s, and 100-200 s).

FIGS. 14A and 14B show digital images and printability of (FIG. 14A) T-inks and (FIG. 14B) U-inks. The scale bars are 5 mm in length.

FIGS. 15A and 15B provide highlighted images of (FIG. 15A) carbon aggregates (purple) in the M2 electrode and (FIG. 15B) a net-like structure (yellow) in a well-printed region of the M1 electrode, which results from the twisted molecular chains.

FIG. 16 show long-term cycling performance of screen-printed M1, M2, and M3 electrodes at a high rate of 6 C. All cells were initially activated at 0.1 C and 0.5 C for three cycles.

FIG. 17 illustrate electrodes screen printed on a bare Al substrate with a 300 mesh screen with pores 0.5 mm in diameter and 420 mesh screen with pores 0.3 mm in diameter. The scale bars are 5 mm in length.

FIG. 18A shows an SEM image of NMC 622 particles in this disclosure.

FIG. 18B shows the size distribution of NMC 622 particles in this disclosure.

FIG. 19 are molecular dynamics models for NMC 622 geometric model, amorphous binder chain model and Super P particle model. A schematic image of the distribution of different regions in the simulation model is shown. Red denotes NMC 622 particles, green indicates binder chains, and lavender represents Super P particles. The two flat plates along the z-direction are marked in cyan.

FIGS. 20A-20C are schematics for the three experimental methods: (FIG. 20A) the M1 method, (FIG. 20B) the M2 method, and (FIG. 20C) the M3 method.

FIG. 21 shows radial distribution functions (RDFs) of inter-NMC 622 particles for the three methods before shear is applied.

FIG. 22 is a schematic for obtaining the viscosity of a rectangular duct.

FIG. 23 is a schematic for ink fabrication process with each photo shown also shown as schematics of the micromorphological ink structure.

### DETAILED DESCRIPTION

A description of example embodiments follows.

### Screen-Printable Electrode Battery Ink

In a first aspect, the disclosure pertains to screen-printable electrode battery inks. A screen-printable electrode battery ink comprises or consists of a slurry of an active ingredient, conductive additive, a binder, and a solvent, the slurry having a solids content from about 40% by weight to about 70% by weight that is uniformly distributed in the solvent, wherein the ink has a thixotropic recovery rate from about 30 seconds to about 90 seconds, and wherein the binder has untwisted molecular chains.

The high solids content and uniform distribution of the ink components in the solvent are achieved by a new mixing approach for making the electrode batteries inks, as described herein. The battery inks of the disclosure can be used to screen print batteries by uniformly squeezing ink through a mesh and transferring it onto a substrate. The inks used in this disclosure possess a viscosity of from about 1 Pa·s to about less than 10 Pa·s, when the shear rate is higher than about 10 s⁻¹. This viscosity range is sufficient for inks to be screen printable. The inks of the disclosure also have a thixotropic recovery rate from about 30 seconds to about 90 seconds. The inks with almost instant thixotropic recovery rate pass through a mesh seamlessly.

The inks of the disclosure comprise or consist of untwisted molecular chains. It has been shown herein that the twisted molecular chains of the bonder act as a net that wrap and pull on the ink particles, which may hinder the ink particles from passing through the mesh of the screen. On the other hand, untwisted molecular chains do not hinder the ink particles from passing through the mesh of the screen enabling well-dispersed ink particles to be effortlessly transferred to an electrode. These untwisted molecular chains enable a well-dispersed ink that that can be transferred to a substrate, such as, but not limited to an electrode, through the mesh during screen printing.

The ink composition of the disclosure can achieve a high solid content comprising or consisting of an active ingredient, conductive additive, and a binder. The total solids content of the ink composition can be from about 40% by weight to about 70% by weight, about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70 (all recited numbers being about wt. %). With regard to the individual components in the ink composition resulting in the total solids content recited above, the active ingredient is present in an amount of from about 70 to about 97 wt. %; the conductive additive is present in an amount of from about 2 to about 20 wt. %; and the binder is present in an amount of from about 1 to about 10 wt. %.

The active ingredient in the screen-printable electrode battery ink is used as part of the battery itself, facilitating the flow of electrons and lithium ions in the battery. Suitable active ingredients include but are not limited to LiNi_{0.6}Mn_{0.2}Co_{0.2}O₂ (NMC 622), LiNi_{0.8}Mn_{0.1}Co_{0.1}O₂ (NMC 811), LiNi_{0.95}Mn_{0.025}Co_{0.025}O₂, LiFePO₄ or graphite. The particle diameter of the active ingredient can be from about 0.2 μm to about 5 μm.

The conductive additive can be carbon fiber, carbon nanotubes, graphene, carbon black powder, such as commercially available as Super P® (diameter in 40 nm from MTI Corporation for lithium-ion batteries). Other particle sizes are contemplated depending upon the type of carbon additive used (e.g., zero-dimensional (0D, such as nanoparticles), one-dimensional (1D, such as nanotubes and nanorods), two-dimensional (2D, such as graphene)). In an embodiment of 0D, the nanoparticles can be from about 30 nm to about 100 nm.

The binder influences the ink's screen-printability and electrode micromorphology and as a result the electrochemical performance of the printed electrodes can be affected. The binder connects the different components within the electrode as well as to the electrode and current collector, providing mechanical stability for the electrode and can improve the electrochemical cycling stability of the electrode. As the solids content in the ink increases, the long polymer chains of the binder are physically entangled and twisted which hinders the ink from passing through the printing screen. This problem is solved by the methods of making the inks of this disclosure by changing the morphology of the polymer chains from being twisted to untwisted. As can be seen in the nonlimiting examples, the untwisting of the polymer chains lowers the viscosity of the high solids ink composition and allows the ink to readily pass through the printing screen, thus resulting in uniform deposition onto a substrate without printing flaws. In view of the resolution of these problems, any compound that can serve as a binder can be used in the ink compositions of the disclosure. For example, suitable binders include but are not limited to polyvinylidene fluoride (PVDF), carboxymethyl cellulose (CMC), styrene butadiene rubber (SBR), polytetrafluoroethylene (PTFE), polyacrylic acid (PAA), alginate, or any combination of the binders. In an embodiment for water system, the combination of binders can be CMC and SBR. In embodiments for organic system, a single binder is used.

Solvent is also present in screen-printable electrode battery ink. The solvent allows the components of the ink to be mixed to uniformity in the solvent, which is important for uniform deposition of the ink by screen printing onto a substrate. The amount of the solvent present in the ink composition is used to achieve a desirable viscosity of the ink. An objective of the ink compositions of the disclosure is to provide high-solid-content inks because they consume less solvent during ink preparation and less energy during drying than low-solid-content inks. The solvent also serves a unique purpose in the inks of the disclosure that impact the viscosity. In methods of making screen-printable electrode battery ink of the disclosure, the solvent is added in two unequal portions at different points in the manufacturing process. It is believed that the addition of the second portion of solvent opens the twisted molecular chains of the binder present in the ink composition and at the same time reduces the viscosity of the ink composition to a screen printable viscosity. For PVDF and PTFE binders, suitable solvents include but are not limited to 1-methyl-2-pyrrolidone (NMP) or dimethylformamide (DMF). For CMC, SBR, PAA and alginate binders, the solvent can be water or other aqueous solvents.

Additionally, the active ingredient for the screen-printed electrode battery ink may be used as an anode in some aspects of embodiments. The active ingredient for an anode electrode ink may comprise or consist of graphite, Li₄Ti₅O₁₂, or silicon containing compounds.

The screen-printed electrode battery ink of the disclosure possesses a uniform distribution of constituent materials, along with a complete and continuous architecture and a uniform component distribution to achieving superior electrochemical performance and an integral structure. The uniform distribution of constituent materials refers to how the ink is printed once on the electrode, which ensures that the electrode is even throughout such that there is not an excess of any component of the ink congregated at any point on the electrode. In addition, the integral structure enables lithium-ion batteries to transport the lithium ions throughout the battery between the electrode and cathode. Further, providing a complete and continuous internal structure and uniform component distribution enables the lithium ions to pass through the electrode efficiently and quickly.

The advantages of the ink compositions of this disclosure are attributed, in part, to the high solid content and the untwisted chains of the binder. This is the first time high solid content (˜60% by weight) screen printable cathode inks for screen printing electrodes have been fabricated. By increasing the solid content of the ink composition, waste of the solvent used in the composition can be significantly reduced, the environmental hazards of organic solvent can be decreased, and the energy requirements expended during drying of the ink can be reduced. By untwisting the chains of the binder, the inks can be readily screen printed onto substrates uniformly without flaws and tortuous channels, thus improving the architecture of the printed substrate and it electrochemical performance.

### Methods for Making the Screen-Pintable Electrode Battery Ink

Based on the understanding of underlying material-structure-property-performance relationships among the molecular chain status, ink dynamic viscosity, and screen printability of inks, as well as micromorphology and electrochemical performance of screen-printed electrodes, an improved method is described to manufacture screen-printable battery inks to optimize their intended performances. In this disclosure, it was demonstrated that high solids content and the untwisting of molecular chains of the binder yielded a superior ink composition with improved screen printability compared to inks with twisted binder chains. The ink compositions made by the manufacturing method of the disclosure not only improved the uniformity of the printability on the substrate but the morphology and architecture of the printed inks on the substrate were improved compared to inks with twisted binder chains.

In a second aspect, the disclosure pertains to methods for preparing a screen-printable electrode battery ink. The methods comprise or consist of a two-step solvent mixing process. According to an embodiment of the method, first amount of a solvent is added to a slurry comprising a conductive additive, an active ingredient, and a binder, and mixing to disperse components of the slurry in the solvent, and then a second amount of the solvent is added to the dispersed slurry. The solvent and the slurry are mixed to form an ink having a uniform distribution of components in the solvent. In this process, the same solvent is added in two unequal parts with the greater amount being added as the first amount and the lesser amount being the second amount. This two-part solvent process enables the ink to reach high solids content of from about 40% by weight to about 70% by weight, and a thixotropic recovery rate from about 30 seconds to about 90 seconds, and molecular chains of the binder that are untwisted.

The first amount of solvent is added in an amount to adequately disperse the components within the ink to achieve uniformity of the components in the solvent. The order of addition of the solvent to some or all of the components of the ink composition can vary provided that uniformity of the components in the solvent is achieved. However, it is important to add the binder to the ink composition before the second amount of the solvent is added. In one embodiment, the first amount of solvent is mixed with the conductive additive, then the active ingredient and the binder are separately added to the solvent/conductive additive. The resulting slurry is mixed to uniformly distribute the solids into the solvent. The second portion of the solvent is then added. In another embodiment, the powders (active ingredient, conductive additive) are hand milled for a period of time to mix the solids together. The first solvent portion was added to the milled power mixture and mixed to uniformly distribute the solids into the solvent to produce a slurry. The binder is then mixed into the slurry to uniformly distribute the binder into the slurry. The second portion of the solvent is then added. In one version, the second portion of the solvent is added dropwise to be able to monitor the final dispersion of all components and the viscosity of the ink composition. In yet another embodiment, the powders (active ingredient, conductive additive) are premixed for a period of time to uniformly mix the powders before the solvent step. The first solvent portion was added to the power mixture and mixed to uniformly distribute the solids into the solvent to produce a slurry. The binder is then mixed into the slurry to uniformly distribute the binder into the slurry. The second portion of the solvent is then added. Example embodiments illustrating the order of addition of components of the inks is provided in Table 1.

The second amount of the solvent is introduced after the binder has been mixed to open the twisted molecular chains and obtain a low viscosity at a high solid content that is suitable for screen printability. Stepwise addition of solvent was found to have different functions with respect to the properties of inks. The first solvent addition disperses the carbon black with a high surface area, and the second addition of solvent opens the twisted molecular chains of the binder to improve the screen printability of the ink. The amount of solvent (based on total solvent percentage) influences the micromorphological structure of the ink, with the solvent percentages based on first solvent portion is in the range of about 75% to about 90% and the second solvent portion range is about 10% to about 25%, with the total solvent added to the ink composition being about 100%. In embodiments, the solvent percentages based on first solvent portion to second solvent portion range from about 90% to about 10%, from about 85% to about 15%, from about 80% to about 20%; from about 75% to about 25%; and increments in between these ranges. In embodiments, a combination of solvents can be used. A combination of solvents can be premixed and divided into portions as discussed above, or the solvents can be added individually as a singular solvent in one portion and an additional singular solvent in another portion. An appropriate combination of solvents can be used provided that the solvents are mutually soluble in each other and with the other components of the ink. As observed in the exemplification, the balance between the solvent amounts in the first position and the second portion is important in the micromorphological structure and electrochemical properties of the ink on the substrate. Too much solvent added in the second portion can negatively affect the carbon dispersion for the whole electrodes, therefore reducing the electrochemical performances of electrodes.

As illustrated in FIG. 23, a certain amount of solvent is separately added in two separate steps: 1) the first part of the solvent is added with the conductive additive to adequately disperse the components within the ink, and 2) the second part of the solvent is introduced after the binder has been mixed to open the twisted molecular chains and obtain a low viscosity at a high solid content. The disentangled and liberated binder endows the ink with low viscosity and outstanding screen printability. In a specific aspect according to the examples, first, Super P (carbon black powder) and the first part of NMP were mixed in a plastic cup; following it, NMC 622 was added and mixed; and then, 10 wt. % PVDF (dissolved in NMP) was added and mixed; finally, the second part of NMP was added and then mixed the whole materials to homogeneous.

### Electrodes Produced by Screen Printing

Fast-charging is key to the widespread adoption of battery-based electric vehicles. However, improving fast charging through architecture optimization is expensive. To reduce costs and expand to commercialization, roll-to-roll screen printing technology was applied to create channels and decrease the tortuosity of electrodes. However, this has not sufficiently solved the forementioned problems.

For the first time, this work successfully opened twisted polymer chains within high-solid-content inks to improve their screen printability and battery performance of as-printed electrodes. With LiNi_{0.6}Mn_{0.2}Co_{0.2}O₂ as an active material, the 60% solid content ink presents superior screen printability after opening the twisted binder chains. As-printed electrode exhibits 33% higher charge capacity at 6 C compared to a printed electrode with chains twisted ink at mass loading of 6.5 mg/cm².

Coarse-grained molecular dynamics simulations were performed to study the underlying mechanism systematically. The new ink preparation procedure of this disclosure provides a scalable, effective strategy for manufacturing screen-printable battery ink and promotes screen-printed electrode technology. Furthermore, the electrochemical performances show that the ink preparation methods of the disclosure can dramatically improve the performances of the screen-printed electrodes in the rate and long-term cycling. The rate performance of an electrode described herein is evaluated based on the rate capability, or how well the electrode handles changes in charging and discharging rates. This is a measure of how quickly the electrode can deliver or store electrical energy.

The inks of the disclosure have outstanding screen printability in that a printed pattern is smooth and uniform. A uniform coating on a substrate will have a micromorphological structure that is continuous and integral with no printed defects, such as the presence of uncoated areas on the substrate, holes and pores. The micromorphological structure can be viewed by Scanning electron microscopy (SEM) or other visual methodologies. In particular, the micromorphological structure of the carbon particles printed on the substrate should be uniform as the uniformity of the coating on the substrate influences the electrochemical properties of the electrode and batteries that incorporate the electrodes of the disclosure. Because the carbon particles are uniformly coated onto the substrate, they create interconnecting channels on the substrate and the presence of untwisted binder allows the channels to align with each other in a non-tortuous pathway.

The high solids content of the ink compositions of the disclosure influence screen printability and mass loading of the ink onto a substrate. Compared to the prior art inks, the high solid content dramatically improved the mass loading of printing layer from 0.4 mg/cm² to 2.2 mg/cm². As such, the inks can be screen printed in a single layer or in multiple layers on a substrate while using less ink and solvent to achieve suitable electrochemical performance properties, compared to prior art inks that have not been produced according to the methods of the disclosure.

Standard methods of screen printing and in particular roll-to-roll screen printing can be used with the ink compositions of the disclosure. The substrate is intended to become an current collector once it is screen printed with the ink compositions. A current collector, such as aluminum, can serve as the substrate to provide a conductive framework for the electrode materials. The current collector serves as a substrate that collects and conducts electrical current to and from the active material in the electrode. In embodiments, a carbon coating layer is used to decrease the electron transfer resistance between the electrode and the (aluminum) current collector, enabling superior electrochemical properties with electrodes.

The screen-printing process involves uniformly squeezing ink through a mesh and transferring it onto a substrate as a single or multiple layers depending on degree of ink loading desired and the electrochemical properties. Because the ink compositions of the disclosure have a high solid content, fewer layers and ink are needed to achieve the desired electrochemical properties compared to prior at inks. In embodiments, a single layer can be printed on a substrate to a thickness of about 10 μm to about 20 μm. In other embodiments, multiple layers of printed ink on the substrate can be from about 2 layers to about 6 layers, with each layer being about 6 μm to about 12 μm thick. In embodiments, the printing screen can be about 300 mesh to about 500 mesh.

The screen-printable electrode battery ink of this disclosure is of high printing quality such that it is suitable for high-resolution printing patterns. These patterns include, but are not limited to printing on etched materials, printing on thin surfaces, precise printing, or printed dots of about 100 μm. Further, inks produced by methods of this disclosure can be used to for printing of pattern-integrated electrodes. This includes but is not limited to printing special shapes, structural designs, or a pattern for a fast-charging electrode battery.

In a nonlimiting example embodiment, electrodes screen printed with the ink compositions of the disclosure have an initial charge capacity of at least about a 200 mAh/g and at least about a 170 mAh/g discharge capacity, an initial Coulombic efficiency of at least about 85%. Further, the best charge capacity observed was at least about 175 mAh/g at 0.5 C and at least about 140 mAh/g at 6 C. Another exhibit of electrochemical performance was performed through long-term cycling wherein a specific charge capacity of at least about 171 mAh/g was observed when cycled at 1 C while maintaining a capacity retention of at least about 81% and a Coulombic efficiency of about 98% for about 100 cycles. The methods of the disclosure reduced the ink viscosity, resulting in the best fluid flow and increasing the intrinsic deformation resistance and force liquid flow, allowing for better particle diffusion to improve printing quality at faster speeds.

Uses for the Inks and Electrode Printed using the Inks Screen-printable electrode ink may be used for the fabrication of fast-charging batteries. The ink allows for reduced tortuosity of electrodes by enhancing electrolyte mass transfer and shortening lithium-ion diffusion. The ink of the disclosure exhibits lowered tortuosity as a result of the uniformly dispersed components of the ink. The fabricated fast-charging batteries may be used in various electronic devices including, but not limited to, fast-charging electric vehicles and fast-charging electronic devices. Further, the inks may be used for other types of electronic devices that are more challenging to manufacture using more traditional methods of battery fabrication. The electronic devices that require more specific types of batteries such as, but not limited to screen-printed microbatteries that may be used for micro electronic devices, wearable batteries with special patterns, flexible, printed and thin film batteries, and used in wearable electronic devices. In addition, the screen-printable electrode ink may be produced to be used in screen-printable inks that require high solid content overall.

### Example Uses

The following are example uses of this disclosure:
1. Screen printing microbatteries.
2. Screen printing wearable batteries with special patterns.
3. Screen printing channels for electrodes to reduce the electrodes' tortuosity for fast-charging batteries.
4. Applied in high solid-content screen printable inks for other fields.
5. Fast-charging electronic devices.
6. Fast-charging vehicles.
7. Flexible, printed and thin film batteries.
8. Wearable electronic devices.

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples.

Thixotropic fluid and recovery rate are intended to mean a fluid which takes a finite time to attain equilibrium viscosity when introduced to a steep change in shear rate. The recovery rate of the inks of the disclosure are almost instant ranging from about 30 seconds to about 90 seconds with about a 100% recovery of the inks.

A slurry is a mixture of denser solids suspended in a liquid, primarily in this disclosure the liquid is the solvent.

Coulombic efficiency, also referred to as Faraday efficiency, describes the efficiency with which charge (electrons) are transferred in a system facilitating an electrochemical reaction, such as but not limited to a battery. In electrochemical reaction systems, a source of loss in efficiency is due to unwanted side reactions, such as but not limited to oxidation of impurities and the formation of a solid electrolyte interface (SEI).

Fast-charging is the ability to efficiently and rapidly charge and discharge electrical energy. It is evaluated by the amounts of capacity at high charge/discharge currents which are described as electrodes charged/discharge at current rates equal to and above 4 C-6 C.

Twisted molecular chains describe long polymer chains of a binder in the screen-printable electrode ink that are physically entangled with other long polymer chains of a binder throughout the composition of the ink. The entangled molecular chains affect the properties of the inks including the viscosity and screen printability, as well as potentially aggregate components of the inks. Untwisted molecular chains describe long polymer chains of a binder in the screen-printable electrode ink that are not physically entangled. The decreased entanglement allows untwisted molecular chains to create many small ink units that are able to transfer through the gap in the screen to the substrate.

A micromorphological feature describes inks on a micro scale such that it is referring to the characteristics of the ink's particles in relation to one another. These features impact the overall characteristics of the inks including but not limited to the viscosity, electrochemical properties, rheological properties, the molecular structure of the inks, how the particles are interacting with each other in the inks, the screen-printability of the inks, and the dispersion of each component.

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

### EXEMPLIFICATION

### Example 1. Opening Twisted Polymer Chains For Simultaneously High Printability and Battery Fast-Charge

Abstract. Fast-charging is key to the widespread adoption of battery-based electric vehicles. However, improving fast-charging through architecture optimization is expensive. To reduce costs and expand to commercialization, roll-to-roll screen printing technology was applied to create channels and decrease the tortuosity of electrodes. For the first time, this work successfully opened twisted polymer chains within high-solid-content inks to improve their screen printability and battery performance of as-printed electrodes. With LiNi_{0.6}Mn_{0.2}Co_{0.2}O₂ as active materials, the 60% solid content ink presents superior screen printability after opening the twisted binder chains. As-printed electrode exhibits 33% higher charge capacity at 6 C than printed electrode with chains twisted ink at mass loading of 6.5 mg/cm². Furthermore, coarse-grained molecular dynamics simulations are performed to study the underlying mechanism systematically. The new ink preparation procedure provides a scalable, effective strategy for manufacturing screen-printable battery ink and promotes screen-printed electrode technology.

Introduction. The widespread adoption of electric vehicles has promoted extensive research on technologies for fast-charging lithium-ion (Li-ion) batteries. In addition to investigating new electrode materials and novel battery chemistries, reducing the tortuosity of electrodes is a widely accepted strategy to enhance the fast-charge capacity since the low-tortuosity structure can enhance electrolyte mass transfer and shorten Li-ion diffusion.[1, 2] Currently, three strategies can be used to achieve low-tortuosity electrodes: 1) fabricating channels through the accumulation of oriented pores, which are generated with chemical, mechanical, and physical methods through sacrificial phases;[3-5] 2) directly producing aligned electrodes with physical or mechanical methods, such as magnetic field application,[6] extrusion,[7] and directional freeze drying;[8] and 3) active loading materials on an aligned template, such as carbonized wood,[9] aligned carbon fibers,[10] or aligned carbonized viruses.[11] Although the above methods established aligned channels within electrodes, reduced tortuosity of electrodes, and improved their fast-charging capacity, most methods are limited to the laboratory demonstration scale and not yet commercially viable due to their complexity, low productivity, high cost, and limited producible size.

People have been using printing technology more than 2000 years ago, and industrial roll-to-roll (R2R) printing has been widely used in manufacturing commercial books, magazines, and newspapers for about two centuries. Because of its many advantages, including the facile process, no added impurities, high output, low cost, and large sample fabricability, R2R printing was recently introduced into batteries[12, 13]. Compared with the traditional bar coating technology to manufacture electrodes, R2R printing offers unique benefits in electrode preparation, including integrating patterns, establishing functional electrode architectures, and extending to large-scale industrial low-tortuosity electrode fabrication. As a typical R2R printing technique,[14] R2R screen printing renders high ink transfer per printing layer. While screen printing has been introduced in battery and capacitor investigations,[15] no research has attempted to apply screen printing to design electrodes with low-tortuosity three-dimensional architectures for fast-charging devices.

Despite having many benefits, the R2R printing battery technology is limited to low mass loading per printing layer. The amount of loading per printing layer is highly dependent on the solid content of the inks. For example, low solid content of 40% leads to a low mass loading of 0.4 mg/cm² for single-layer screen printing,[16] whereas a relatively high solid content of 60% leads to a high areal mass loading of 2.2 mg/cm² per printing layer in this work. Moreover, high-solid-content inks consume less solvent during ink preparation and less energy during drying than low-solid-content inks. Although ink with high solid content is necessary for the industrialization of screen-printed batteries, the high solid content can negatively impair the rheological properties and screen printability of inks. Unfortunately, few studies on the formula-property-printability relationship have been reported, and to date, most screen-printable Li-ion cathode inks have a solid content below 40 wt. %.[17-20] This solid content is much lower than that of electrode slurries used for traditional bar-coating manufacturing processes (greater than 55%).[21]

In addition, as an indispensable component in electrode inks, the binder influences both the ink printability and the electrode micromorphology and therefore affects the electrochemical performance of as-printed electrodes. Previous works have indicated that both the weight content and number average molecular weight (Mn) of the binder play a critical role in screen printing.[22, 23] Specifically, raising the weight content and selecting a high-Mn binder enhances the connectivity between components within inks, but it can impair the screen printability of inks.[24] Concurrently, inks with highly twisted molecular chains exhibit poor thixotropic properties and screen printability.[25] Beyond its significant influence on screen printability, the binder is critical to the electrochemical performances of as-printed electrodes. As an electrode component, the binder connects the different components within the electrode as well as the electrode and current collector, providing mechanical stability for the electrode and therefore improving the electrochemical cycling stability.[26] However, the excessive binder can impede the transport of electrons and ions in the electrode and thus negatively affects the rate performance. Therefore, the exploration and optimization of binders are necessary to reach both excellent printability under a high solid content and elevated battery performance.[27]

In this work, for the first time, the effect of the molecular chain status (twisted or untwisted) within inks on the rheological properties and screen printability of inks produced through three different ink preparation methods is reported. The influence of the screen printability of inks on the structure of screen-printed electrodes was further investigated via X-ray computed tomography (XCT). Additionally, the electrochemical properties of screen-printed electrodes were analyzed to reveal the underlying material-structure-property-performance relationships among the molecular chain status, ink dynamic viscosity, and screen printability of inks, as well as micromorphology and electrochemical performance of screen-printed electrodes. Ultimately, an optimized ink preparation procedure was developed to achieve excellent screen-printable inks with untwisted molecular chains while ensuring homogeneous dispersion of the components at a high solid content (60%). Results show that the innovative ink preparation procedure can dramatically improve the performances of the screen-printed electrodes in the rate and long-term cycling. In addition, coarse-grained molecular dynamics (CGMD) are performed to investigate the underlying mechanisms at the micro-level since it is computationally more effective and enables the studied simulation system to have much longer time scales and larger size scales. Through CGMD simulations, the relationships between different ink preparation procedures and performance metrics, including shear behaviors, ink component distribution, and fluidity during the printing process, was revealed. Overall, this work developed an optimal ink preparation methodology to ensure both excellent screen printability and high battery performance, which paves the way toward the industrial manufacturing of low-tortuosity electrodes through screen printing for fast-charging.

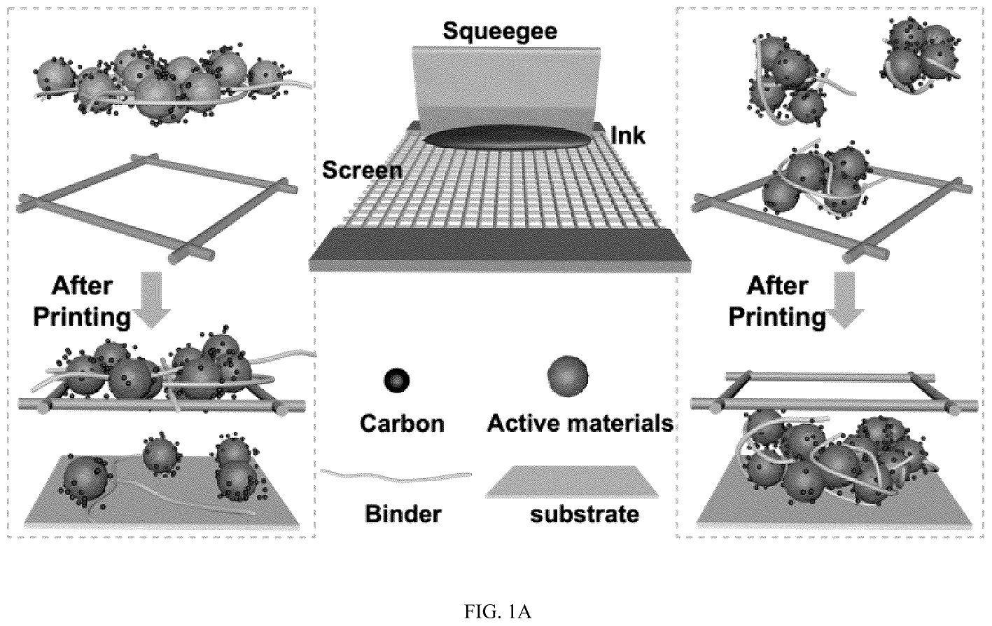

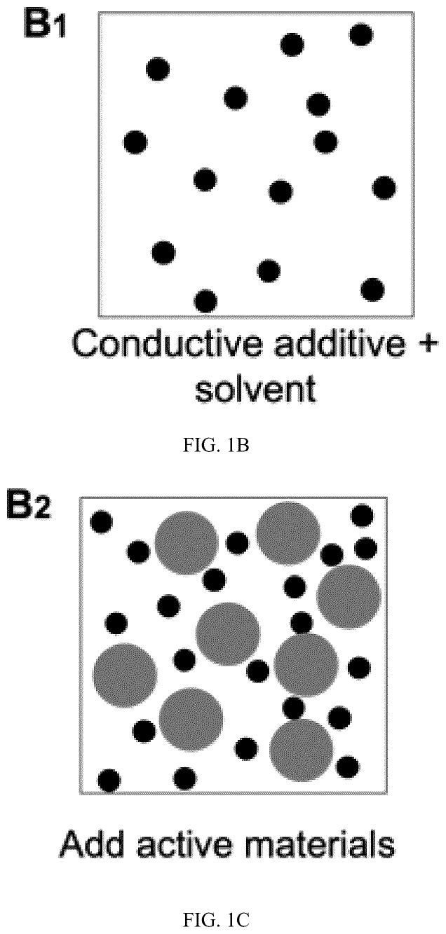

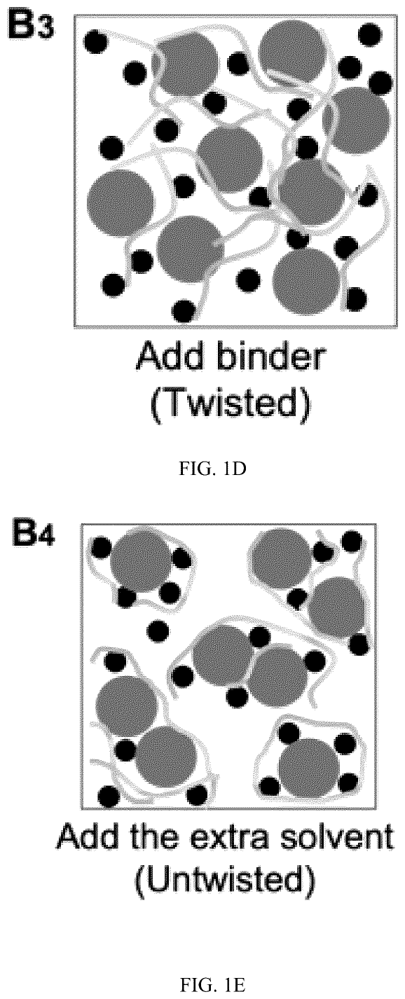

Results and Discussion. Uniformly squeezing ink through a mesh and transferring it onto a substrate is essential to reach outstanding screen printability. The binder within inks significantly affects the rheological properties and, therefore, the screen printability of the ink. Especially under a high ink solid content, the long polymer chains of the binder are physically entangled and twisted, thereby increasing the ink viscosity and reducing the screen printability. To achieve excellent printability, herein, three ink preparation procedures were investigated and an approach to open twisted polymer chains was developed. FIG. 1A shows the relationship between the screen printability of inks with twisted (left panel) and untwisted (right panel) molecular chains, respectively. Twisted molecular chains act as additional nets, wrapping and pulling on the ink particles, hindering them from passing through the mesh of the screen. In the opposite situation, the molecular chains within the ink are untwisted. In this case, an equivalent amount of particles and polymer chains as in the previous case form an opened and well-dispersed ink. These well-dispersed units can be effortlessly transferred to the substrate through the mesh during screen printing.

Based on the above-discussed relationship between the molecular chain status of the binder within the ink and the resulting screen printability, a novel and straightforward procedure to prepare the screen-printable electrode ink was designed, named the two-step approach.

FIGS. 1B-1E illustrate the preparation process of the two-step approach and the corresponding micromorphological feature within the ink. A certain amount of solvent is separately added in two separate steps: 1) the first part of the solvent is added with the conductive additive to adequately disperse the components within the ink, and 2) the second part of the solvent is introduced after the binder has been mixed to open the twisted molecular chains and obtain a low viscosity at a high solid content. The disentangled and liberated binder endows the ink with low viscosity and outstanding screen printability.

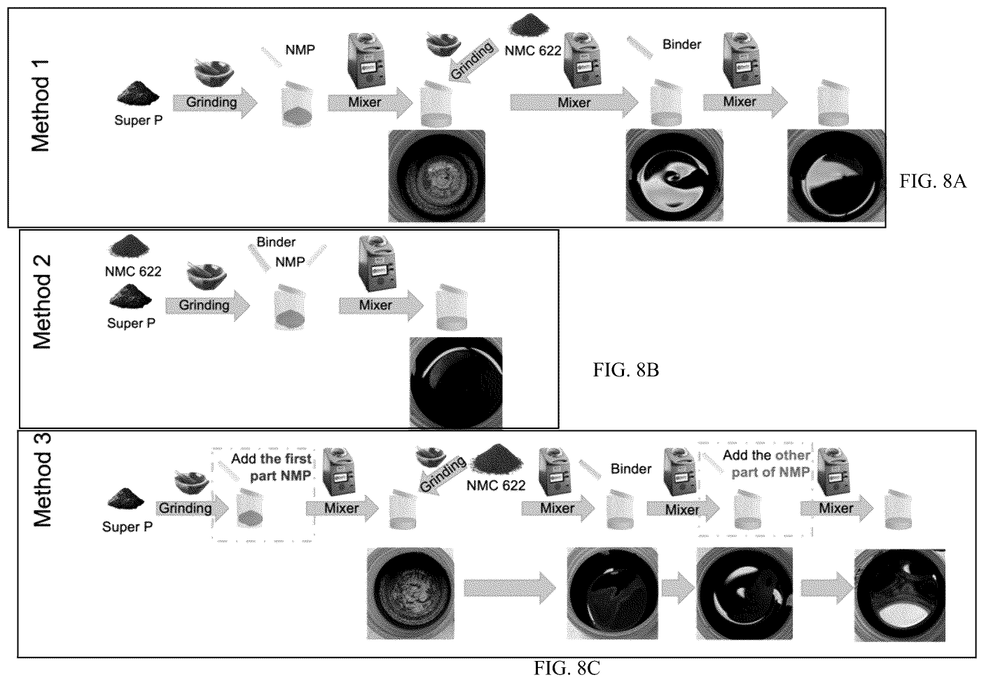

To demonstrate the effects of the molecular chain status on the rheological properties and screen printability, 60% solid content inks were prepared with various molecular chain statuses containing LiNi_{0.6}Mn_{0.2}Co_{0.2}O₂ (NMC 622) (active material), super P (conductive additive), polyvinylidene fluoride (PVDF, binder), and 1-methyl-2-pyrrolidone (NMP, solvent). Specifically, ink was prepared by Method 1 (M1), corresponding to the traditional method, i.e., dispersing super P, adding NMC 622, and mixing the binder solution; the ink was produced by Method 2 (M2), matching the most commonly used method in the laboratory, i.e., mixing all components; and ink was fabricated by Method 3 (M3) corresponding to the two-step approach mentioned above, separating the solvent (NMP) into two parts and adding the parts separately. As mentioned above, the M1 and M2 inks are twisted molecular chain inks (named “T-Inks”) since the binder solution is added at the end and creates additional nets. In contrast, the M3 ink is an untwisted molecular chain ink (named “U-Ink”). The corresponding mixing processes and optical images of the mixtures in each step are displayed in FIGS. 8A-8C, in detail. Although all three inks are macroscopically homogeneous, their internal micromorphological structure needed to be elucidated through rheological property evaluation.

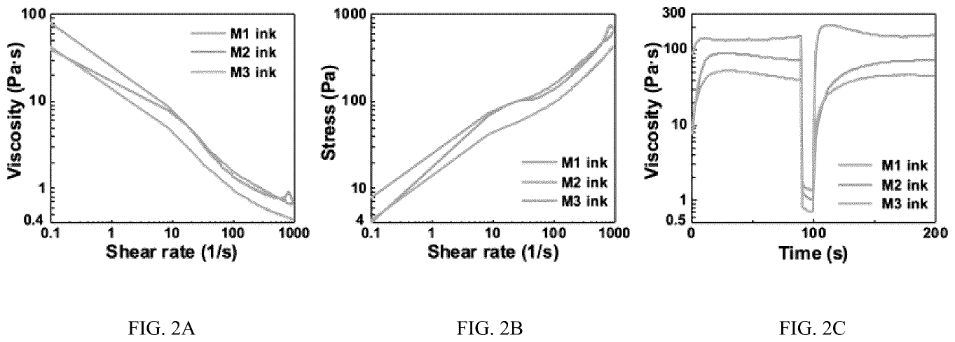

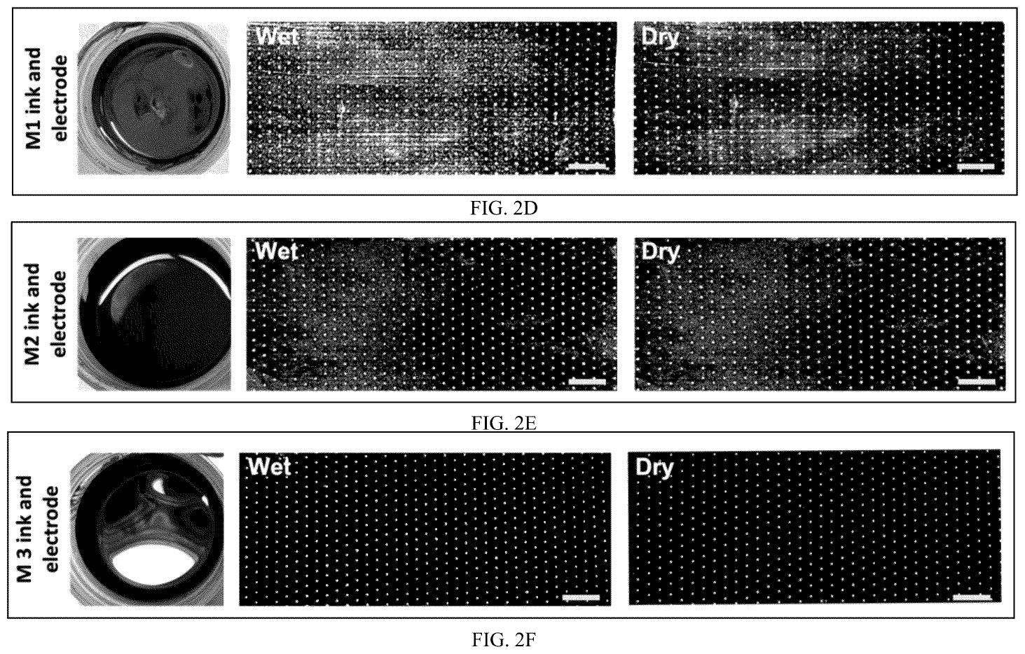

Rheological studies were carried out to study the flow behaviors and thixotropy of the M1, M2, and M3 inks. The viscosity-shear rate plots show that all inks exhibit shear-thinning behavior, as presented in FIG. 2A. The viscosities of all inks decrease as the shear rate increases and remain below 10 Pa·s when the shear rate is higher than 10 s⁻¹, which is in the proven screen a printable range of 1-10 Pa·s.[28] Furthermore, the viscosities of the M1, M2, and M3 inks are in decreasing order, and the viscosity differences among the inks are more pronounced at low shear rates. The strongest interaction among components within the M1 ink contributes to the force between the heavily intertwined molecular chains. This force is further reflected in the fact that the M1 ink has a yield shear stress approximately twice that of the M2 and M3 inks, as displayed in FIG. 2B. Therefore, although M2 ink is T-ink, its molecular chains are less twisted than M1 ink. The thixotropy recovery rate and recovery time are the other critical rheological properties for screen-printable inks. Ideally, an excellent screen-printable ink has an almost instant thixotropic recovery rate, which allows the ink to pass seamlessly through the mesh. To mimic and investigate the rheological behavior of inks during a high-speed screen printing process, the thixotropy recovery rates and times were evaluated by a three-step thixotropy test via the successive application of 0.1 s⁻¹, 200 s⁻¹, and 0.1 s⁻¹ shear rates in three intervals, 0-90 s, 90-100 s, and 100-200 s. As exhibited in FIG. 2C, the M1, M2, and M3 inks were 100% recovered at 58, 85, and 36 seconds after being subjected to a high shear rate of 200 s⁻¹, respectively. The shortest recovery time for the M3 ink suggests that this ink can pass through the mesh more facilely than the others, which agrees with the above description.

The screen printability of ink is evaluated by assessing the quality of the printed product. The M1 electrode (FIG. 2D) exhibits extensive exposure of the aluminum (Al) foil without transferred particles, demonstrating a low printing quality and poor ink screen printability. Compared to the M1 electrode, the M2 electrode (FIG. 2E) shows slightly smaller but still noticeable bare Al foil exposure in the electrode cover region. The improvement in screen printability results from the lower viscosity of the M2 ink than that of M1 ink. In addition, both the M1 and M2 electrodes exhibited no improvement in printing quality during the drying process. The poor printing quality of these electrodes illustrates that T-Inks are not suitable for use in high-resolution printing patterns. In contrast, as presented in FIG. 2F, there are no visible defects on the M3 electrode printed with the U-Ink; thus, M3 enables precise printing of pattern-integrated electrodes.

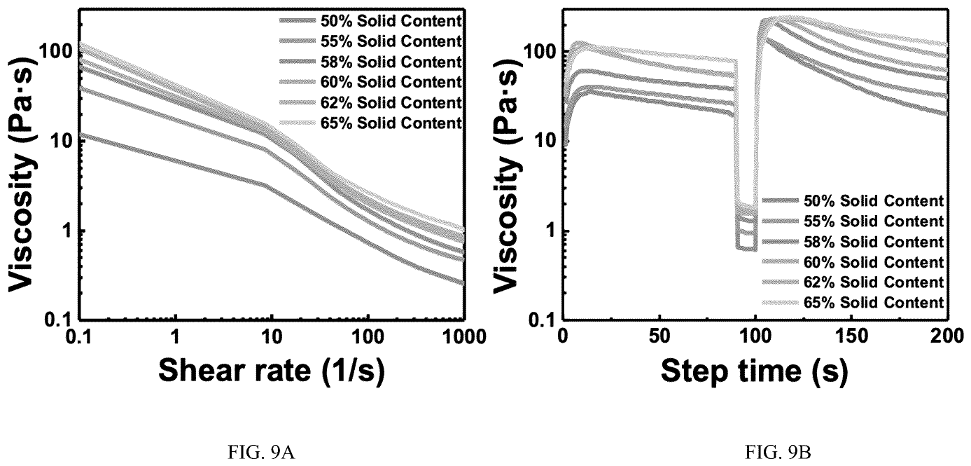

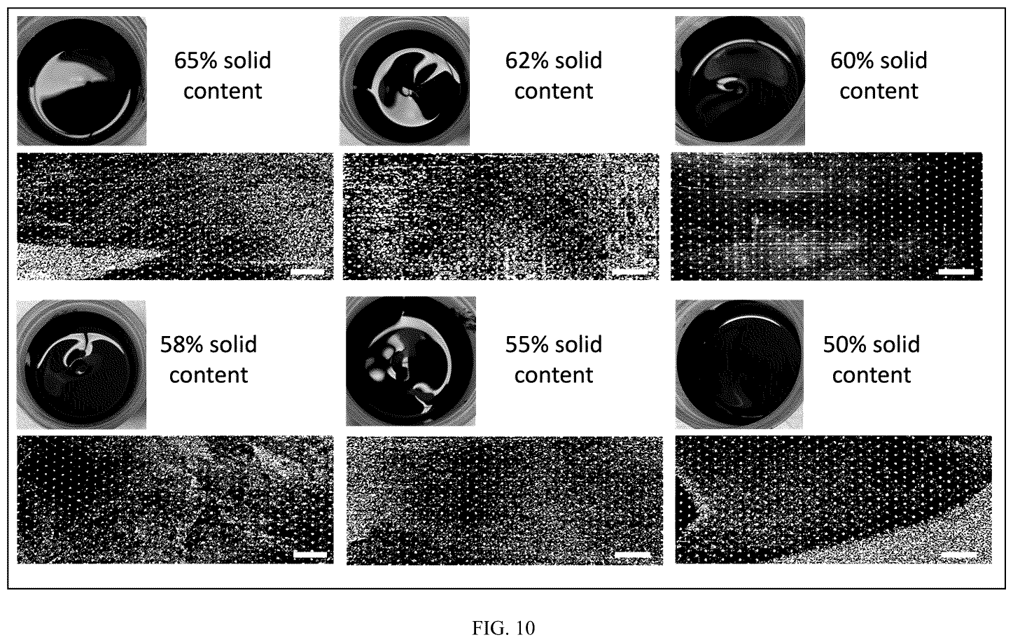

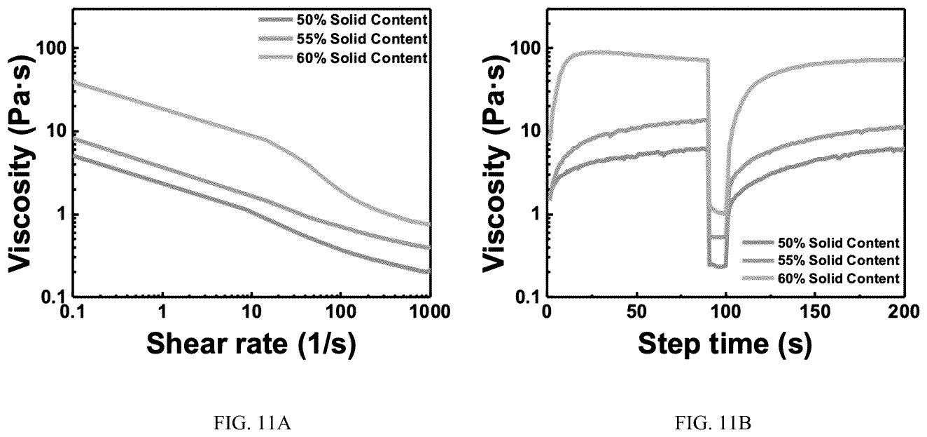

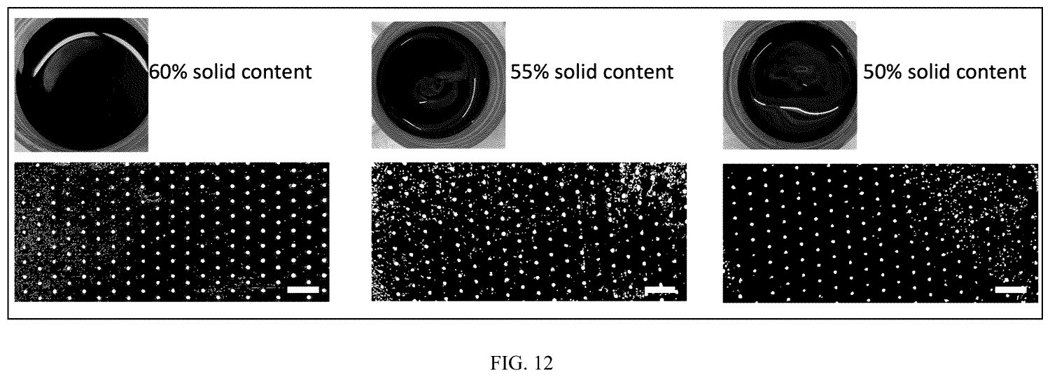

Although the reduced solid content can obviously decrease the viscosity and improve the screen printability of inks, the improvement is negligible since the molecular chains within low-solid-content inks remain twisted. To demonstrate this relationship, the rheological properties and screen printability of M1 inks under six different solid contents from 50% to 65% (FIGS. 9A, 9B and 10) and that of M2 inks under solid contents from 50%, 55%, and 60% (FIGS. 11A, 11B and 12) were evaluated. Although the viscosity of the ink sharply decreases as the solid content decreases, the screen printability has not been enhanced, obviously. Notably, observing the shear rate of 200 s⁻¹, the viscosity of the 50% solid content M1 ink (0.49 Pa·s) is lower than the 60% solid content M3 ink (0.65 Pa·s), but the screen printability of M1 ink is still poor. These results demonstrate the screen printability of inks is greatly dominated by the molecular chain status within inks.

To further demonstrate the relationship between the molecular chain status within inks and their screen printability, more T-Inks and U-Inks were designed, prepared, and characterized. The mixing processes of these 60% solid content inks are summarized in Table 1.

TABLE 1
Details of the ink fabrication processes and a brief summary of the
printability and molecular chain conditions for a series of inks.

| | | | | | | molecular |
|---|---|---|---|---|---|---|
| # | Step 1 | Step 2 | Step 3 | Step 4 | Printability | chains situation |
| 1 | Mixing the super P and | Add the NMC 622 | Add high solid content | — | Bad | Twisted |
| | NMP | | binder solution | | | |
| 1.2 | Mixing super P and half | Add the NMC 622 | Add the other half of | — | Bad | Twisted |
| | of binder solution | | binder solution | | | |
| 1.3 | Pre-mixing the powders | Add NMP | Add half of high solid | Add the other half of | Bad | Twisted |
| | for 1 h at 500 rpm | | content binder solution | high solid content | | |
| | | | | binder solution | | |
| 1.4 | Mixing the super P and | add the other ½ of | Add NMC 622 | Add high solid content | Bad | Twisted |
| | ½ NMP | NMP | | binder solution | | |
| 2 | Mixing powders by | Add binder solution | — | — | Bad | Twisted |
| | hand milling | | | | | |
| 3 | Mixing Super P and | Add NMC 622 | Add high solid content | Add the other part of | Good | Untwisted |
| | part of NMP | | binder solution | NMP | | |
| 3.2 | Mixing powders by | Add NMP | Add high solid content | Add NMP step by step | Good | Untwisted |
| | hand milling | | binder solution | | | |
| 3.3 | Pre-mixing the powders | Add part of NMP | Add high solid content | Add the other part of | Good | Untwisted |
| | for 1 h at 500 rpm | | binder solution | NMP | | |

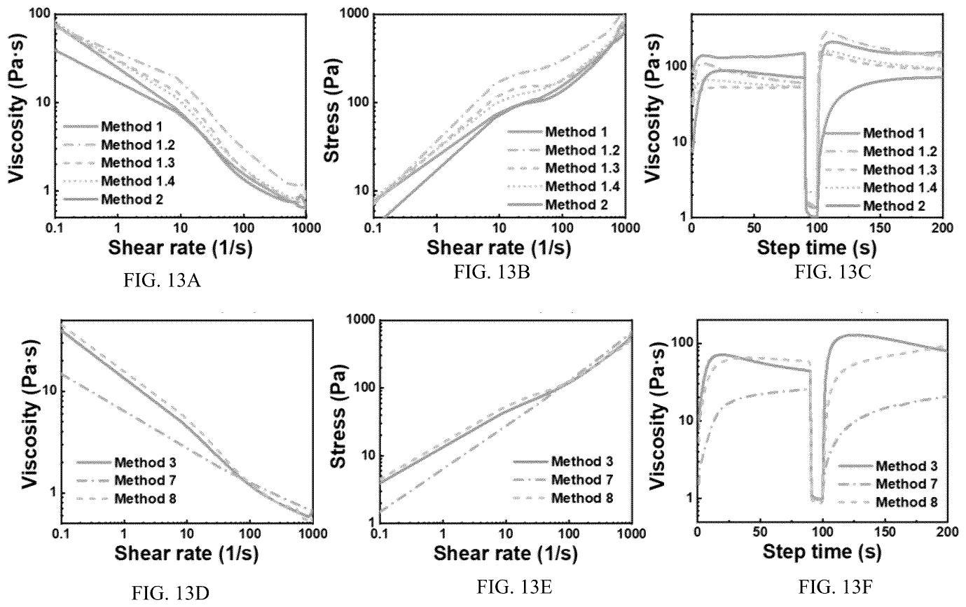

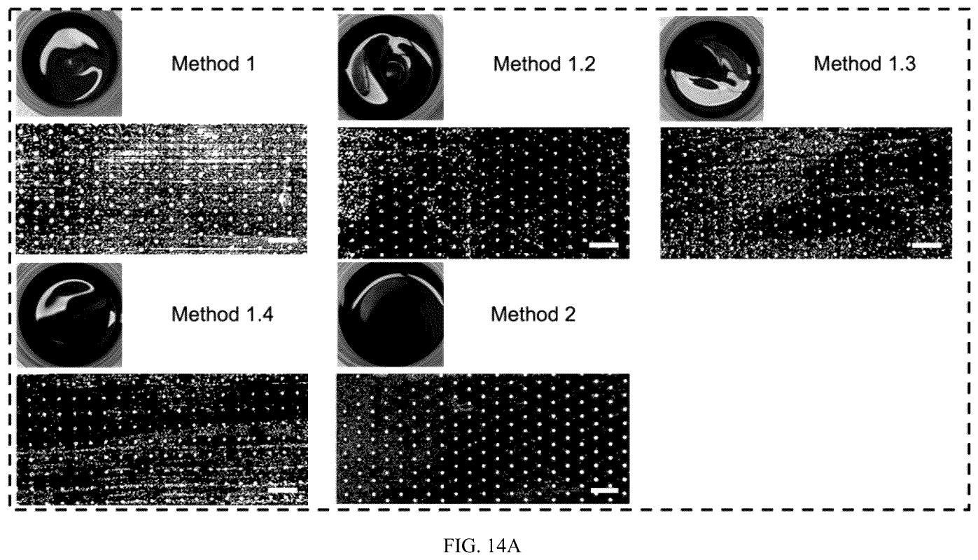

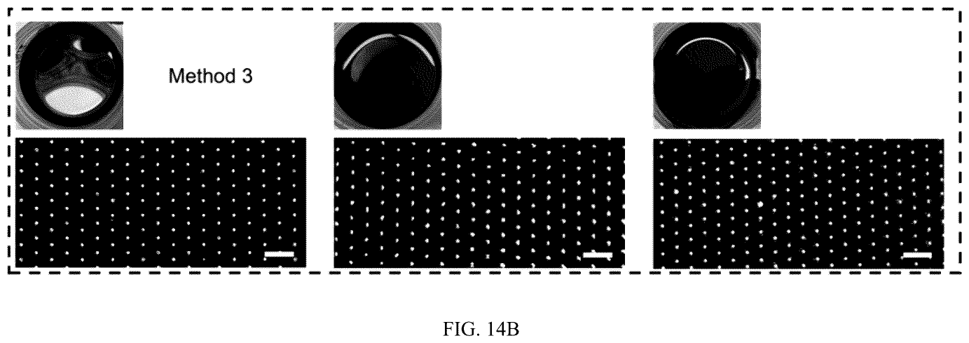

Briefly, regardless of the initial mixing steps, adding the binder solution in the last step causes the molecular chains inside the produced ink to twist, and introducing extra solvent can open the twisted molecular chains. The corresponding rheological properties are displayed in FIGS. 13A-13F. The viscosity of T-Inks is marginally higher than that of U-Inks, while the yield shear stress of the former is slightly lower than that of the latter. The viscosity and yield stress differences between the various inks are due to the faint pulling force from the twisted chain networks. Although all T-Inks have a viscosity in the screen-printable region of 1-10 Pa·s and exhibit remarkable quick thixotropic recovery after being subjected to a high shear rate, their screen printability is still poor. Although these eight inks are evenly mixed from a macro perspective, the printing quality of electrodes screen-printed using these inks differs. As demonstrated in FIGS. 14A and 14B, conspicuous defects are only apparent in the electrodes screen-printed using T-Inks, while the quality of the electrodes printed using U-Inks is outstanding.

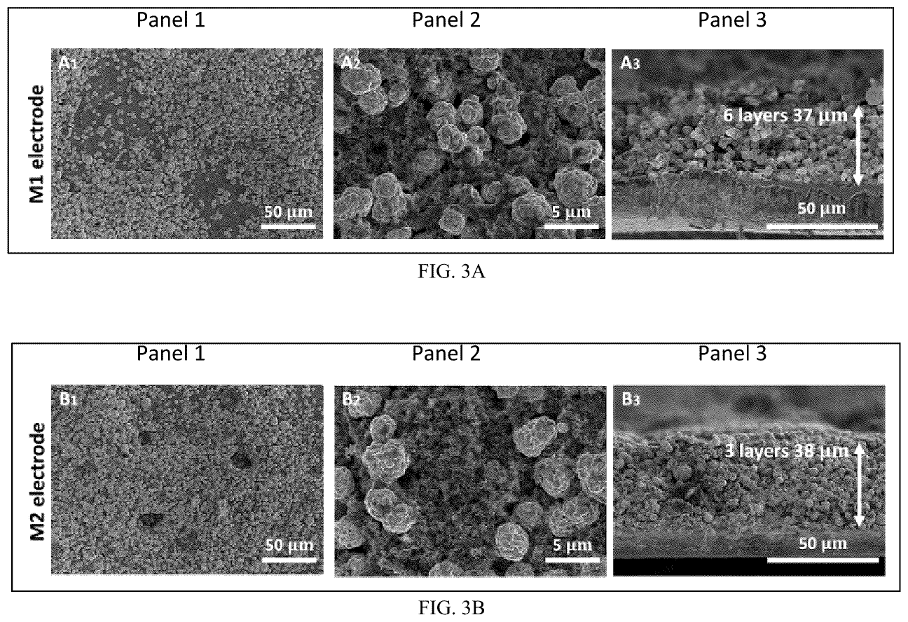

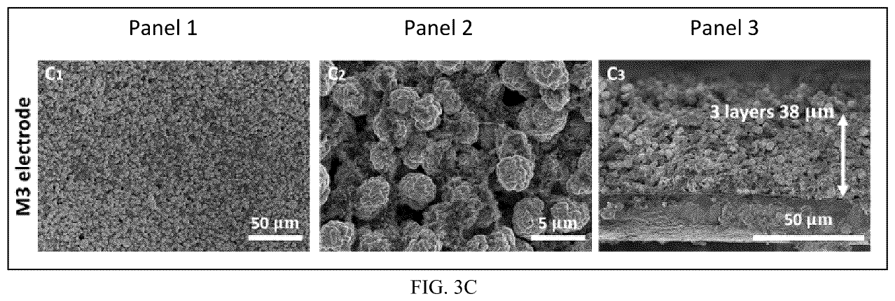

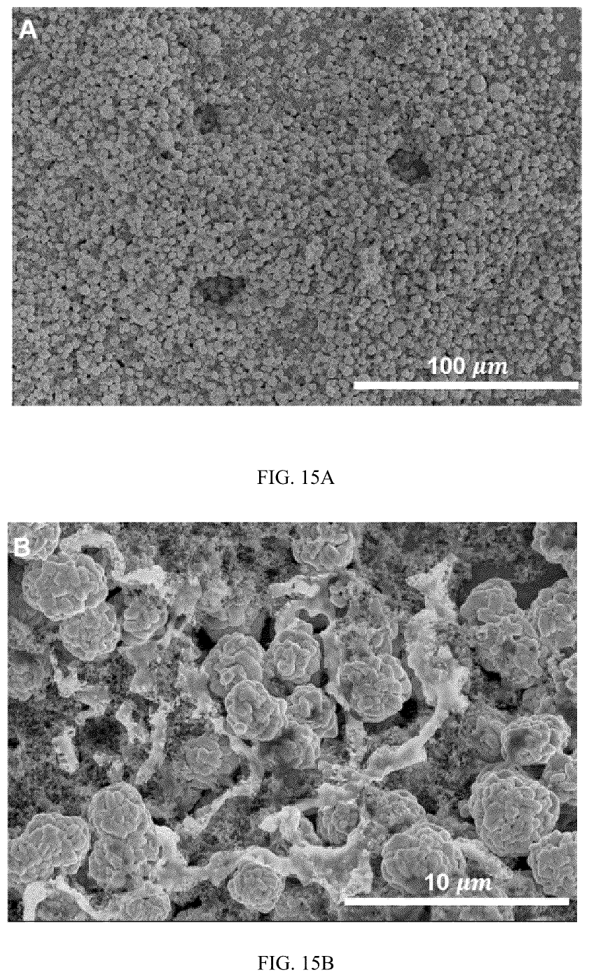

The morphology of the M1, M2, and M3 electrode coating areas was further characterized using scanning electron microscopy (SEM) to evaluate the printing quality and component dispersion in more detail. Top-view images were collected for the one-layer printed electrodes on bare Al foil, and cross-sectional images were taken for the multilayer printed electrodes. The low-magnification SEM images depict the screen printability and conductive additive distribution of the printed electrodes. Consistent with the previous discussion, the M1 and M2 electrodes exhibit poor screen printing quality. Two large bare Al foil regions with a small amount of scattered adhered active material are visible on the M1 electrode FIG. 3A (panel 1)), and many unexpected holes are visible on the surface of the M2 electrode (FIG. 3B (panel 1) and highlighted in FIG. 15A). In comparison, FIG. 3C (panel 1) displays the surface of the printed M3 electrode is flat and smooth without apparent defects. The printing quality affects the electrochemical properties of as-printed electrodes by influencing their internal structure. In addition to the printing quality, the dispersion of the components, especially the uniformity of the dispersion of carbon particles, determines the electrochemical performance of Li-ion batteries. Homogeneously dispersed carbon particles create interlinking channels, improve electron transfer in the cathode electrode, and ensure outstanding rate performance. As presented in FIGS. 3A (panel 1) and 3C (panel 1), the high-quality printed regions of the M1 and M3 electrodes present a uniform carbon particle distribution. In contrast, some carbon particle aggregates appear on the surface of the M2 electrode. Thus, compared to the M1 and M3 inks, the carbon particle distribution of the M2 ink is unsatisfactory. The images at 10× magnification expand the features of each electrode. Excitingly, net-like structures generated by the twisted molecular chains are hidden inside a well-printed region within the M1 electrode, as shown and highlighted in FIG. 3A (panel 2) and FIG. 15B. The length of one observable chain is approximately 20 μm, nearly half the distance between two fibers in our screen mesh (48 μm). Therefore, large amounts of net-like structures can work as additional nets and pull on the particles so that they remain on the surface of the screen. FIG. 3B (panel 2) displays a tiny defect region in FIG. 3B (panel 1), in which many carbon particles are aggregated without the inclusion of NMC 622 particles. Unlike the M1 and M2 electrodes, no net-like structure is observed, and the carbon particles uniformly encapsulate NMC 622 particles on the M3 electrode, as shown in FIG. 3C (panel 2).

Cross-sectional SEM images of multilayer-printed M1, M2, and M3 electrodes are displayed in FIGS. 3A (panel 3), 3B (panel 3), and 3C (panel 3). The multilayer printing process maintained an electrode mass loading of approximately 6.5 mg/cm² and a thickness of approximately 38 μm on a rugged substrate. Different from the M2 and M3 electrodes, the M1 electrode is distinctly uneven, with some discontinuous contact between particles. Therefore, even though printing more layers can increase the mass loading of electrodes, their internal structural drawbacks cannot be fixed entirely. More importantly, the M1 electrode was printed with six layers to achieve the target mass loading, while the M2 and M3 electrodes were printed with three layers. Obviously, the more layers required for printing, the higher the cost of the industrial manufacturing process. Therefore, poor screen printability destroys the accuracy and reduces the manufacturing efficiency of printed electrodes for achieving the same mass loading.

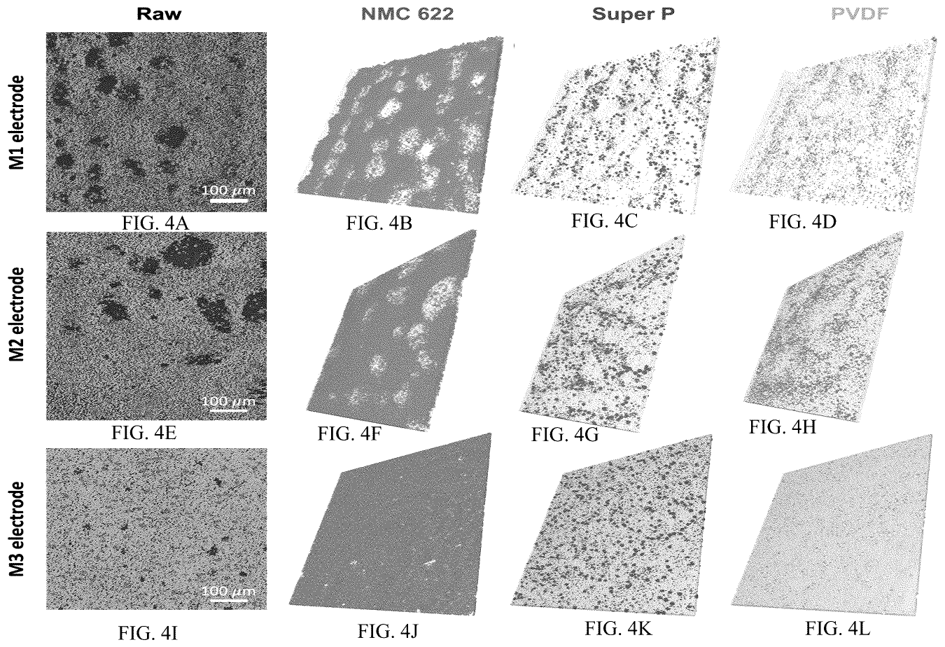

For a more comprehensive analysis of the relationship between inks and the component distribution within screen-printed electrodes, XCT was employed to study and label the distributions of NMC 622 (yellow), super P (red), PVDF (green), and pores (blue) for screen-printed one-layer M1, M2 and M3 electrodes. All computed tomography areas were materials-printed area, therefore, the larger blue areas indicate the worse printability. In contrast to SEM, which only evaluates the local surface morphology, XCT is a powerful approach to segmentally scan, probe the internal structure, and generate 3D reconstructions of screen-printed electrodes.[29] A 2D image of the M1 electrode is shown in FIG. 4A, in which the blue color corresponds to pores. A large number of blue areas demonstrate the relatively poor printing quality of the M1 electrode. The distribution of NMC 622 is highlighted in FIG. 4B in yellow. As the matrix material, NMC 622 particles are densely located on the well-printed area but are more sparsely located at apparent edges of defects. In FIG. 4C, super P is labeled in red. In addition to being greatly hindered by unexpected defects, the dispersion of super P is unsatisfactory within defect-free areas. Even worse, a large amount of binder is aggregated inside the M1 electrode, as marked in green in FIG. 4D. Therefore, the twisted molecular chains within the M1 ink not only impair its screen printability but also negatively affect the dispersion of the binder in the screen-printed electrode. Despite having slightly smaller hole areas than the M1 electrode, the M2 electrode is still displayed to be incomplete (FIG. 4E). Furthermore, carbon and binder are highly aggregated in the M2 electrode. Compared to the M1 electrode, the carbon even shows a high degree of aggregation in the electrode (FIG. 4G). Meanwhile, the large amount of green parts in FIG. 4H clearly shows that the distribution of the binder is also uneven in the M2 electrode. And the larger amount of green parts within one-layer printed M2 electrode results from the more electrode-covered area than that of the one-layer printed M1 electrode. The 2D image of the M3 electrode is exhibited in FIG. 4I, in which the blue areas refer to pore areas, and the M3 electrode has far fewer pores than the M1 and M2 electrodes. Moreover, NMC 622 occupies the main fraction of the M3 electrode and forms an integrated area. Compared to the component dispersion within the M1 and M2 electrodes, the M3 electrode has a more homogeneous and reasonable distribution of carbon (FIG. 4K) and the binder (FIG. 4L). In short, inks with untwisted molecular chains can ensure high printing quality and uniform distribution of constituent materials. In addition to the carbon distribution being important, structural integrity is essential to Li-ion batteries. Twisted molecular chains generate many unexpected voids that damage the interconnections within screen-printed electrodes and further compromise their electrochemical performance. Predictably, this situation can be worsened after multiple screen printings.

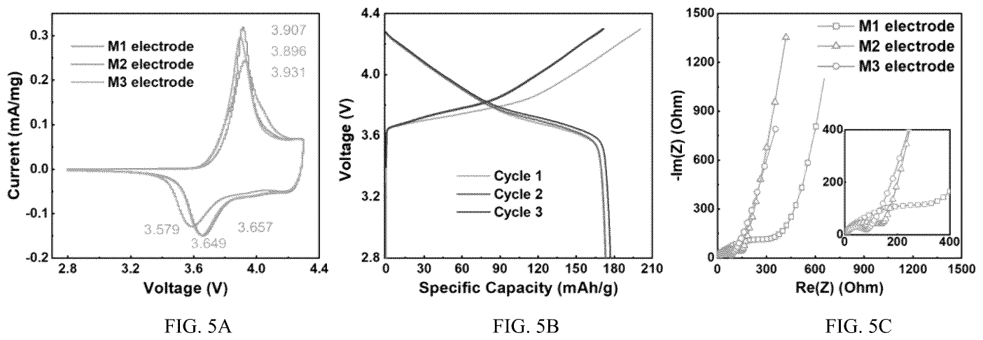

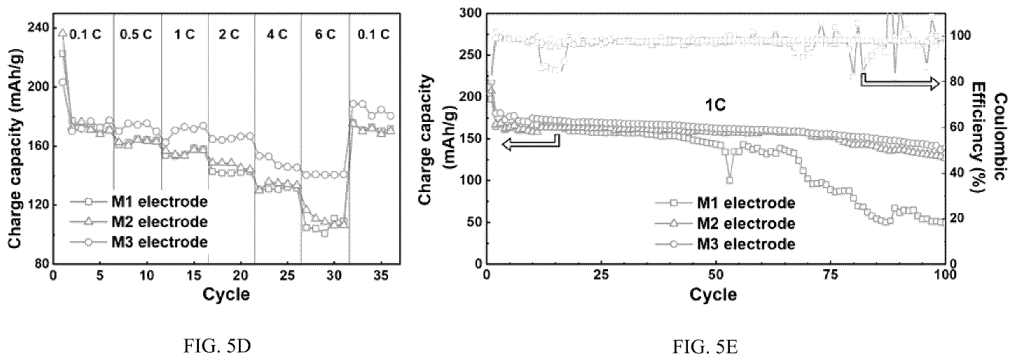

To evaluate the effects of the structural integrity and component dispersion within printed electrodes on their electrochemical properties, screen-printed M1, M2, and M3 electrodes were assembled in coin cells with Li metal as the anode. The cyclic voltammetry (CV) curves (FIG. 5A) show clear oxidation peaks at approximately 3.9 V and reduction peaks at approximately 3.6 V for all electrodes, corresponding to the redox transition of Ni²⁺/Ni⁴⁺.[30] The peak separation implies an overpotential. The potential gap of the M3 (247 mV) and M2 (250 mV) electrodes are much smaller than that of the M1 (352 mV) electrode, indicating that the M3 and M2 electrodes have better reaction kinetics and a lower degree of polarization than the M1 electrode. The large overpotential in the M1 electrode mainly results from poor structural integrity and weak interconnection between components within the printed electrodes.

The first three charge and discharge curves of the M3 electrode at a current rate of 0.1 C are displayed in FIG. 5B. The initial charge and discharge capacities of the M3 electrode are 201 and 173 mAh/g, respectively. The initial Coulombic efficiency is 86.1%, and the first cycle inefficiency mainly results from the formation of a solid electrolyte interface (SEI) on the electrode. The following two cycles exhibit similar charge and discharge capacities, suggesting that screen-printed M3 electrodes are reasonably stable. The Nyquist plots of the M1, M2, and M3 electrodes are compared in FIG. 5C. All batteries exhibit semicircles in the high-frequency region and Warburg tails in the low-frequency region; these features indicate the charge transfer resistance and ion diffusion resistance, respectively. The charge transfer resistance of the M1, M2, and M3 electrodes sequentially decreases, which reflects the effect of the ink preparation process on the charge transfer kinetics. The low charge transfer resistance of the M3 electrode is attributed to the uniform carbon distribution and complete and continuous internal electrode architecture.

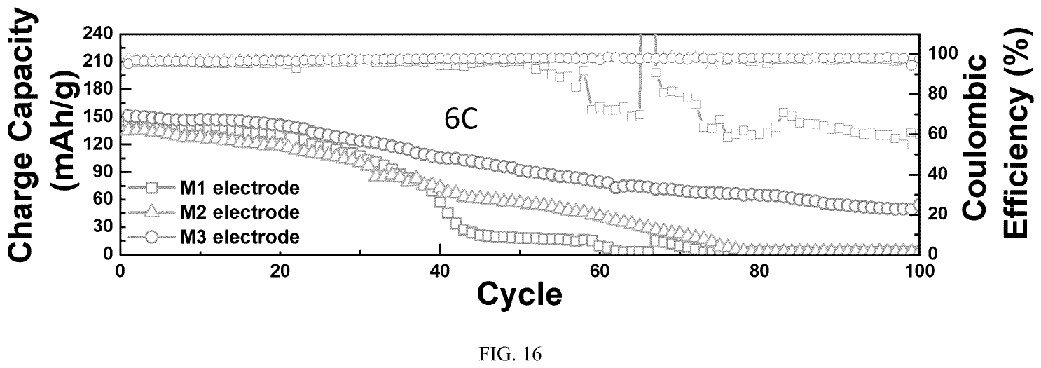

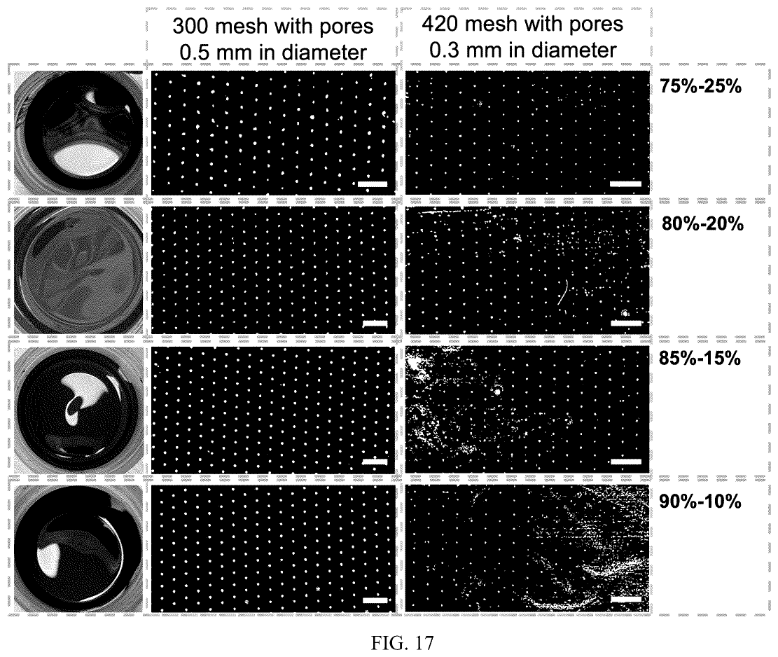

The rate performance of these screen-printed electrodes was evaluated by changing at various rates of 0.1, 0.5, 1, 2, 4, and 6 C, and constant discharging at C/3, as exhibited in FIG. 5D. At 0.5 C, the M3 electrode (175 mAh/g) exhibits a superior charge capacity than the M1 (163 mAh/g) and M2 (163 mAh/g) electrodes, and the advantage is even more apparent at high rates. At 6 C, the charge capacity of the M3 electrode is 141 mAh/g, which is much higher than those of the M1 (106 mAh/g) and M2 (110 mAh/g) electrodes. This result agrees that the M3 electrode has a lower charge transfer resistance. The substantial specific capacity of the M3 electrode at a high current rate is attributed to the more complete and continuous internal architecture and more uniform binder dispersion than the M1 electrode, as well as the more uniform carbon distribution than the M2 electrode. The long-term cycling performance of the screen-printed M1, M2, and M3 electrodes at a charge rate of 1 C and a discharge rate of C/3 is shown in FIG. 5E. All cells were initially activated at 0.1 C and 0.5 C for three cycles. When cycled at 1 C, the M3 electrode exhibited a specific charge capacity of 171 mAh/g. Concurrently, the electrode maintained superior capacity retention of 81.0% and high Coulombic efficiency of 98% for 100 cycles. Noteworthy, the M1 electrode exhibits significant charge capacity that decays at approximately 65 cycles. Moreover, the Coulombic efficiency of the M1 electrode is unstable and vigorously fluctuates starting from 70 cycles. Both the unsatisfactory charge capacity stability and fluctuating Coulombic efficiency of the M1 electrode are ascribed to its lack of architectural integrity. The long-term cycling performance of three kinds of electrodes at a high charge rate of 6 C and a discharge rate of C/3 is exhibited in FIG. 16. At a high current rate, the stability of all the cells has been significantly reduced due to the lithium metal dendrite issue. In the initial 20 cycles, the M2 electrode displayed the lowest charge capacity due to its carbon dispersion is nonuniform. The M1 electrode exhibits dramatic decay of charge capacity from 35 cycles because of its nonuniform components interconnection with twisted binder. Therefore, a complete and continuous internal architecture and a homogeneous component distribution are critical for printed electrodes to achieve superior electrochemical performance.

Understanding the mechanism and optimizing preparation parameters are important for the scale-up of the novel ink preparation process, i.e., the two-step approach, for large-scale screen-printed electrode manufacturing. The stepwise addition of NMP has different functions with respect to the properties of inks: the first NMP addition disperses carbon with a high specific surface area, and the second NMP addition can open twisted molecular chains and improve the screen printability of the ink. Therefore, the proportions of NMP added in the first and second steps during untwisted ink fabrication (named “1^{st} sol-2^{nd} sol”) influence the micromorphological structure of the ink. To investigate in detail the effect of the 1^{st} sol-2^{nd} sol value on inks prepared by the two-step approach, 60% solid content M3 inks were prepared with 1^{st} sol-2^{nd} sol values of 75%-25% (75% of NMP is mixed in the first step, and the other 25% is mixed in the second step; other labels follow a similar nomenclature), 80%-20%, 85%-15%, and 90%-10%.

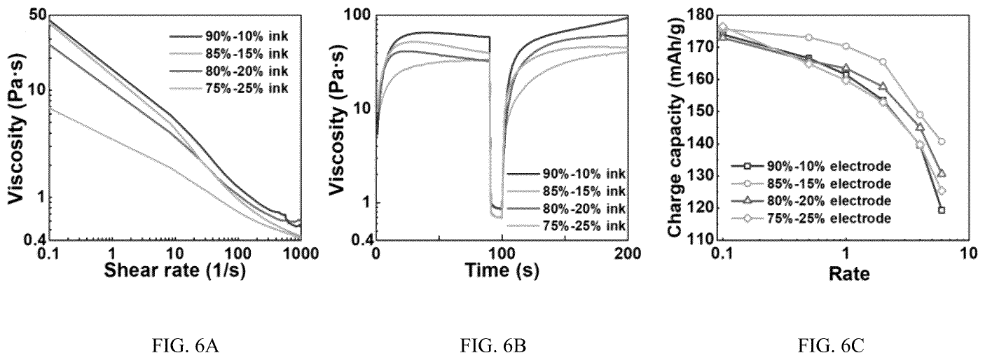

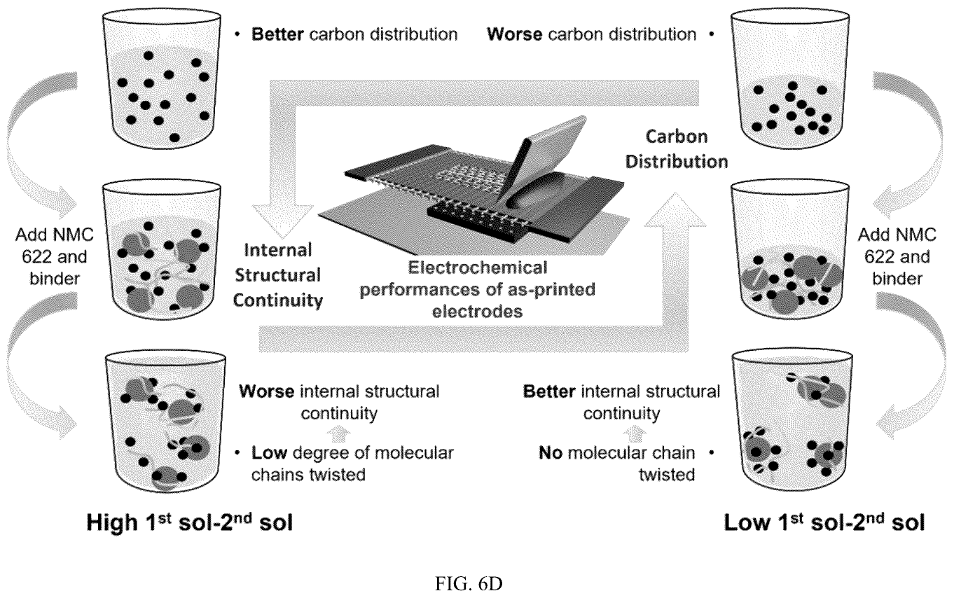

The rheological properties and screen printability of the abovementioned inks were measured. The viscosity of these inks increases with the 1^{st} sol-2^{nd} sol value, as shown in FIG. 6A. At a shear rate of 0.1 s⁻¹, the viscosity of the 90%-10% ink (45.5 Pa·s) is over six times that of the 75%-25% ink (6.9 Pa·s). The viscosity of the low 1^{st} sol-2^{nd} sol inks (where more NMP is mixed in the second step than in the first step) indicates their components have weak connections. FIG. 6B shows the 100% recoverability of these inks in 60 s after supporting a high shear rate of 200 s⁻¹. Results indicate the rheological properties of these inks are in a reasonable screen printable region. To further evaluate the printability of these inks under different conditions, screen printing was performed on a bare Al substrate using a 300 mesh screen with pores 0.5 mm in diameter and a 420 mesh screen with pores 0.3 mm in diameter, as described in FIG. 17. Benefiting from the untwisted molecular chains, all inks display outstanding printability with the 300 mesh screen. However, M3 inks with various 1^{st} sol-2^{nd} sol values exhibit greater differences in screen printability for the high (420)-mesh screen, and the quality of as-printed electrodes weakens with increasing 1^{st} sol-2^{nd} sol value.

As mentioned above, the composition distribution and the internal structural integrity of the electrode significantly affect the electrochemical performance of screen-printed electrodes, and these factors are affected by the 1^{st} sol-2^{nd} sol value during ink preparation in the two-step approach. For example, ink with a high 1^{st} sol-2^{nd} sol value (where more NMP is mixed in the first step than the second step) has a homogeneous carbon distribution because a large amount of solvent is added in the first step; however, the internal structural integrity of the resulting as-screen-printed electrode will be lacking owing to the limited screen printability. Therefore, adjusting the 1^{st} sol-2^{nd} sol value is an effective pathway to fabricate the best screen-printed electrode in different situations to balance the carbon distribution and internal structure and further achieve outstanding electrochemical properties. The rate performances of M3 electrodes with different 1^{st} sol-2^{nd} sol values are displayed in FIG. 6C, wherein the half-cell was charged at 0.1, 0.5, 1, 2, 4, and 6 C and discharged at C/3. All screen-printed electrodes exhibit excellent and similar specific charge capacities at the low test rate of 0.1 C (174, 176, 173 and 175 mAh/g for 90%-10%, 85%-15%, 80%-20% and 75%-25% electrodes, respectively). Starting from 0.5 C, the 85%-15% electrode displays a higher specific charge capacity (173 mAh/g) than the other electrodes (˜166 mAh/g), and the difference increases with the increasing current rate. At 6 C, the 85%-15% electrode exhibits a specific charge capacity of 141 mAh/g, which is higher than those of the 90%-10% (119 mAh/g), 80%-20% (131 mAh/g), and 75%-25% (125 mAh/g) electrodes.

The underlying mechanism of the effects of the 1^{st} sol-2^{nd} sol value on the carbon distribution and screen printability of inks fabricated by the two-step approach is illustrated in FIG. 6D. With a low 1^{st} sol-2^{nd} sol value, a lower amount of solvent in the first step impacts the homogeneity of the carbon particle dispersion. This inhomogeneity is further exacerbated by adding NMC 622 particles and a highly viscous binder solution. Concurrently, the subsequent addition of more solvent is helpful for opening twisted molecular chains while enlarging the distance between the well-dispersed units. A large distance between these well-dispersed units can weaken their mutual forces and decrease the viscosity of the ink, thus reducing the difficulty of transporting the well-dispersed units through the mesh and achieving well-printed patterns and an electrode with a complete integral structure.

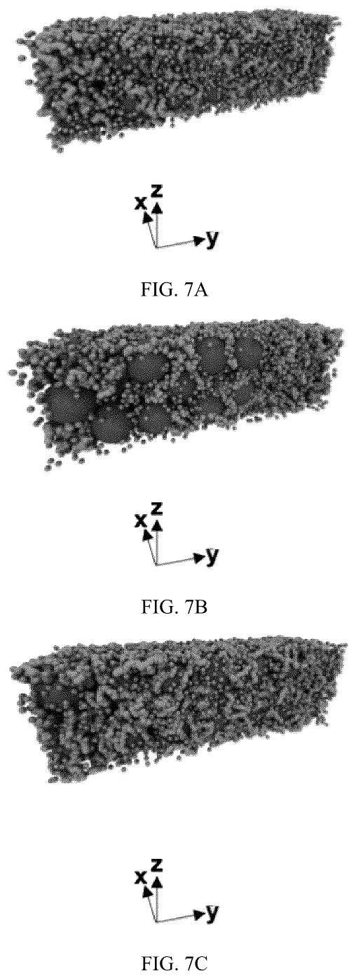

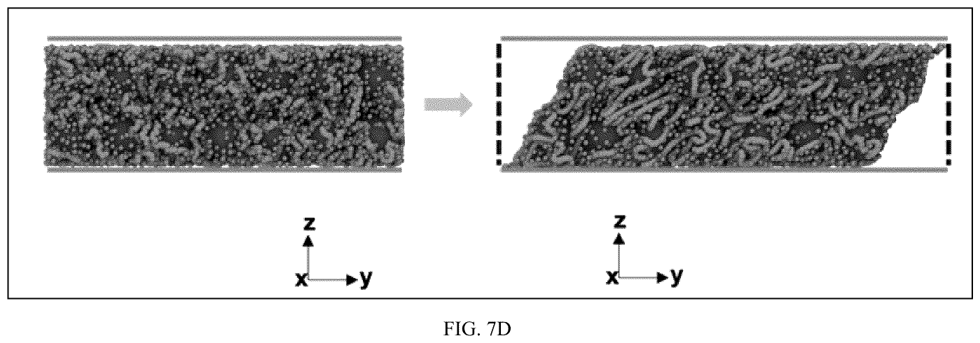

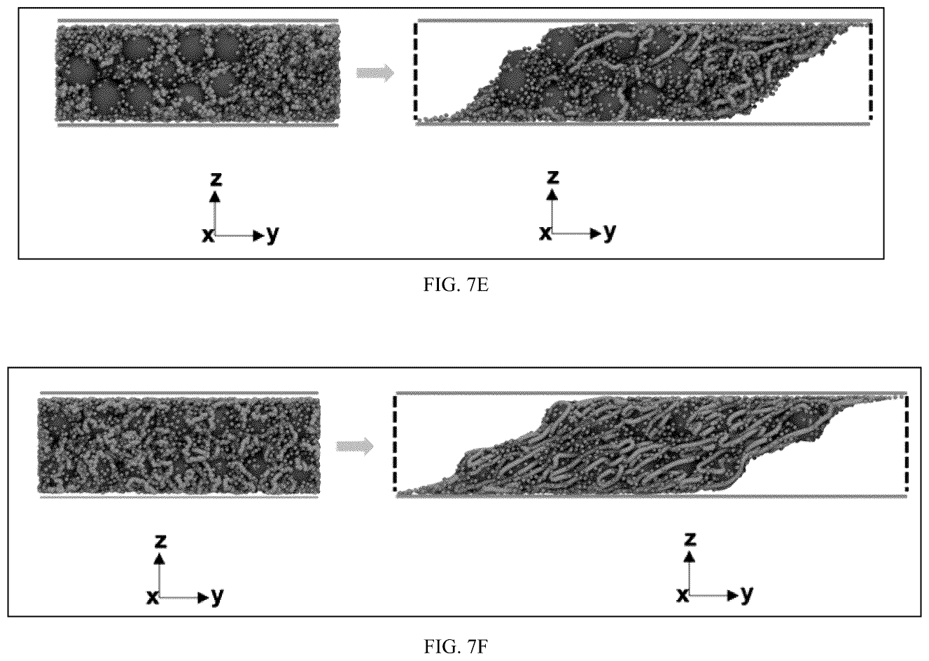

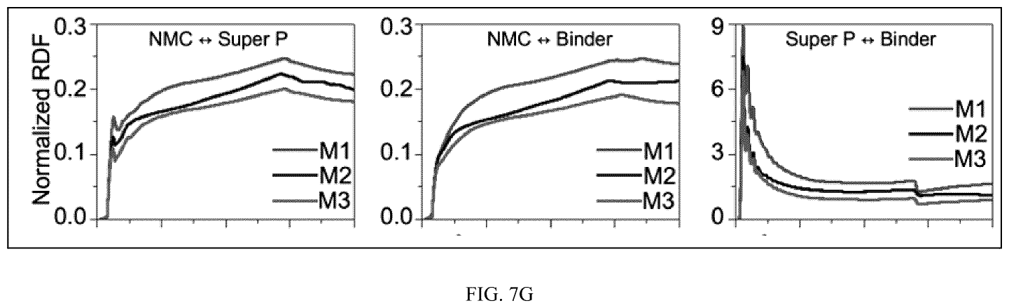

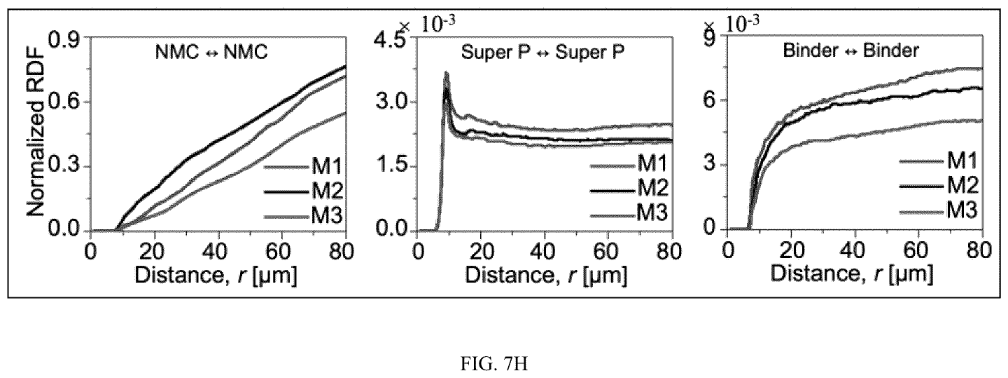

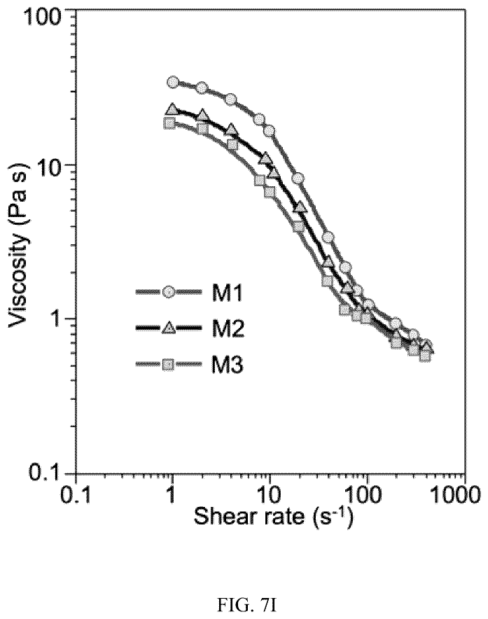

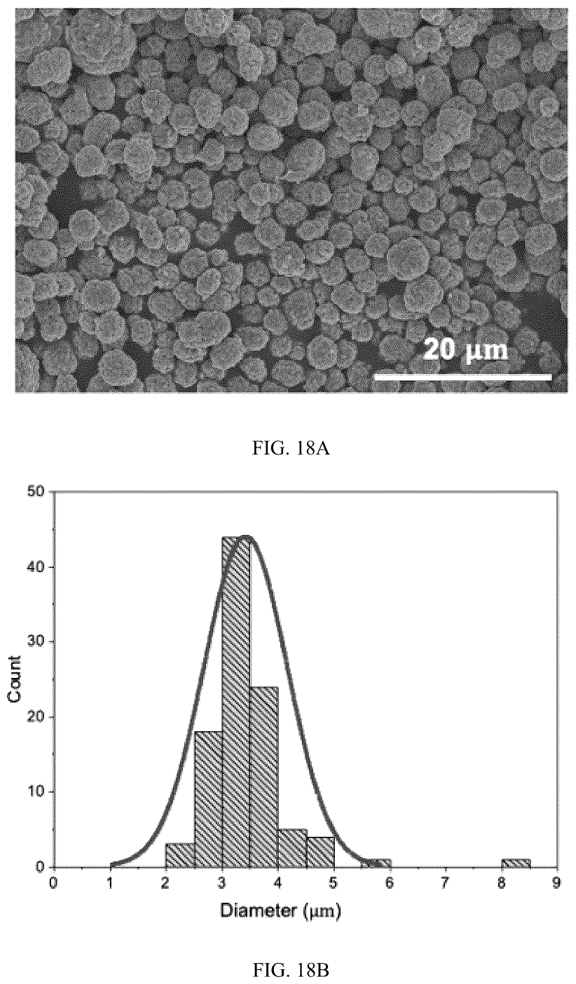

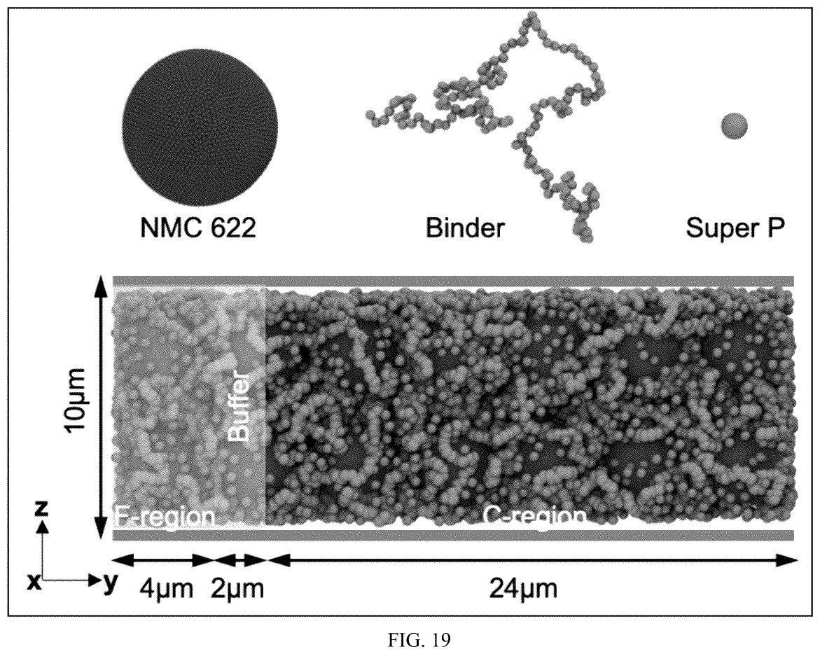

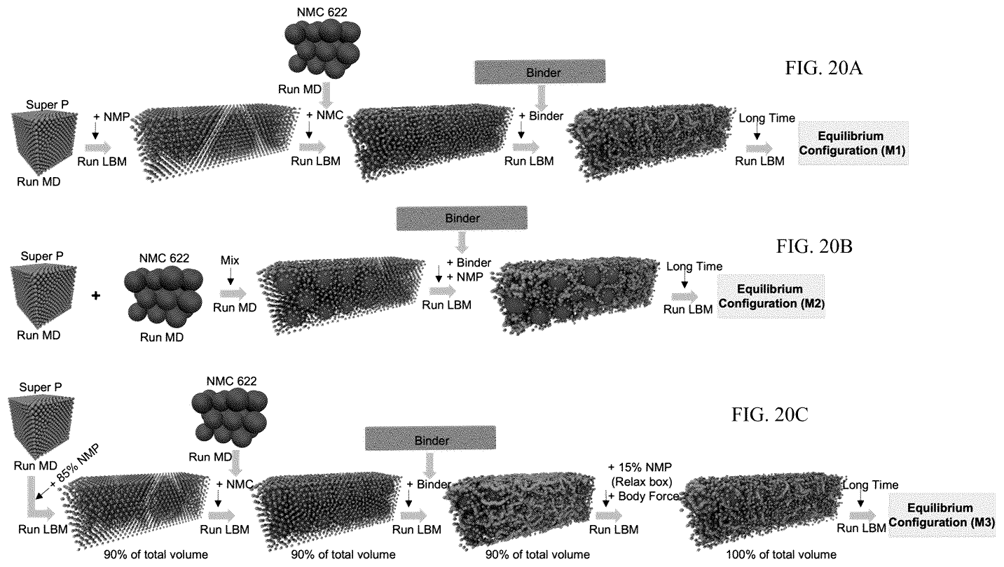

To better understand the underlying mechanisms by which different methods affect the ink printing quality, a CGMD model was developed to both qualitatively describe the effects of the shear flow behavior in the printing process and quantitatively characterize the viscosities under different shear rates (FIGS. 7A-7I), based on previous studies.[31, 32] NMC 622 particles (FIGS. 18A, 18B and 19) were modeled as spherical particles with a diameter of 3.5 μm. The binder (FIG. 19) was modeled as coarse-grained polymer chains. Super P particle (FIG. 19) was modeled as a series of point-like spherical particles. The solvent was implicitly considered by using its density and viscosity as inputs through the lattice Boltzmann method (LBM). Based on the measured component distributions and the fixed addition pathway in the experimental preparation procedures (FIGS. 20A-20C), the three preparation methods are illustrated using one-to-one correspondence CGMD simulation. The configuration for the final addition path was adopted to perform a simulation for a sufficiently long time using LBM integration to obtain the equilibrium configuration. The obtained equilibrium configurations for the three preparation methods are shown in FIGS. 7A-7C.

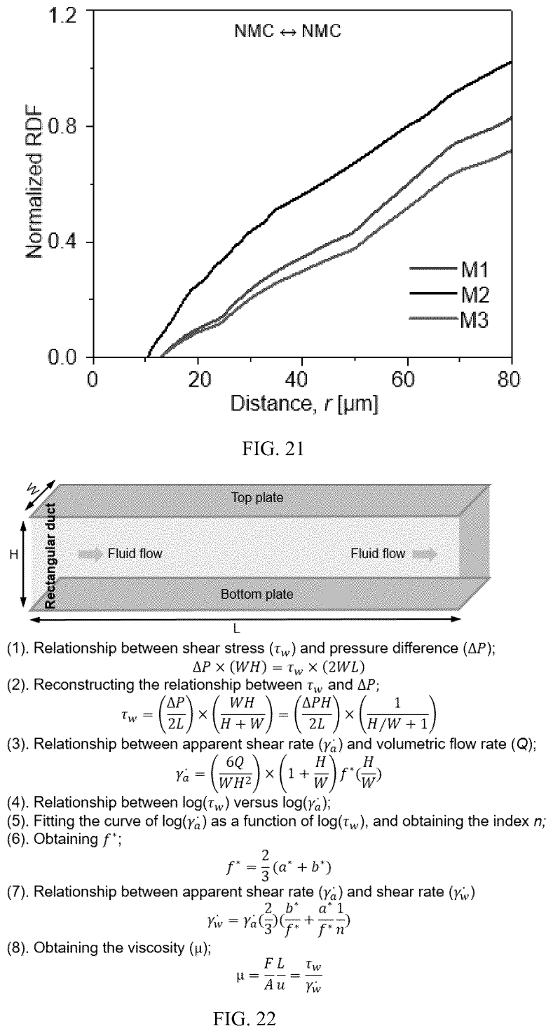

Based on the equilibrium configurations, shear flow simulations were first conducted to qualitatively describe the effect of the different methods on the shear behavior of the ink during the printing process. Periodic boundary conditions were applied in the x and y directions, while the z direction was bounded by two flat plates. A shear velocity of 20 s⁻¹ was applied on the top flat plate corresponding to the z-plane to drive the shear flow. FIGS. 7D-7F show snapshots of the ink printing processes of the three methods at two times with different states: 0 s (left) before a shear flow is applied; 0.553 s (right) after the shear flow is applied to the top plate. Under the same shear flow and timescale, particle aggregates tend to expand most easily in the M3 system, followed by the M2 and M1 systems. In addition, the compactness or fluidity of particles was quantified by the interparticle radial distribution function (RDF). FIGS. 7G and 7H show the RDFs for different types and the same types of particles, respectively. Except for the inter-NMC particle RDFs, the RDF amplitudes for the particles show an increasing trend in the order M3, M2, and M1, which indicates that M3 can lead to the best shear fluidity. The inter-NMC particle RDF amplitude is the highest in the M2 system, which is caused by the local concentration of more NMC particles in the initial configuration and the limited timescale of the shear flow. To illustrate this point, the inter-NMC particle RDFs were plotted for the initial configurations (0 s) in FIG. 21. The comparison shows that the inter-NMC particle RDF amplitude is the highest in the M2 system. However, the decrease rate of the RDF amplitude in the M2 system is higher than that in the M1 system and close to that in the M3 system. That is, if the timescale is long enough, then the inter-NMC particle RDF amplitude in the M2 system will be between those in the M1 and M3 systems. The RDF amplitudes for all the particles are lowest in the M3 system because the system moves further within the same timescale, leading to increased particle spacing and a more dispersed distribution between particles. Conversely, the M1 system spreads outward only slightly within the same timescale, which gives rise to poor mass transport for particles and denser particle distribution. Similarly, the RDF amplitudes for all the other particles in the M2 system are between those in the M1 and M3 systems because the diffusion velocity of the M2 system is between those of the M1 and M3 systems within the same period, leading to a middle range of particle dispersion. These qualitative findings and the fluidities of the inks considered suggest that M3 can lead to a better quality of ink for printing, followed by M2 and M1.

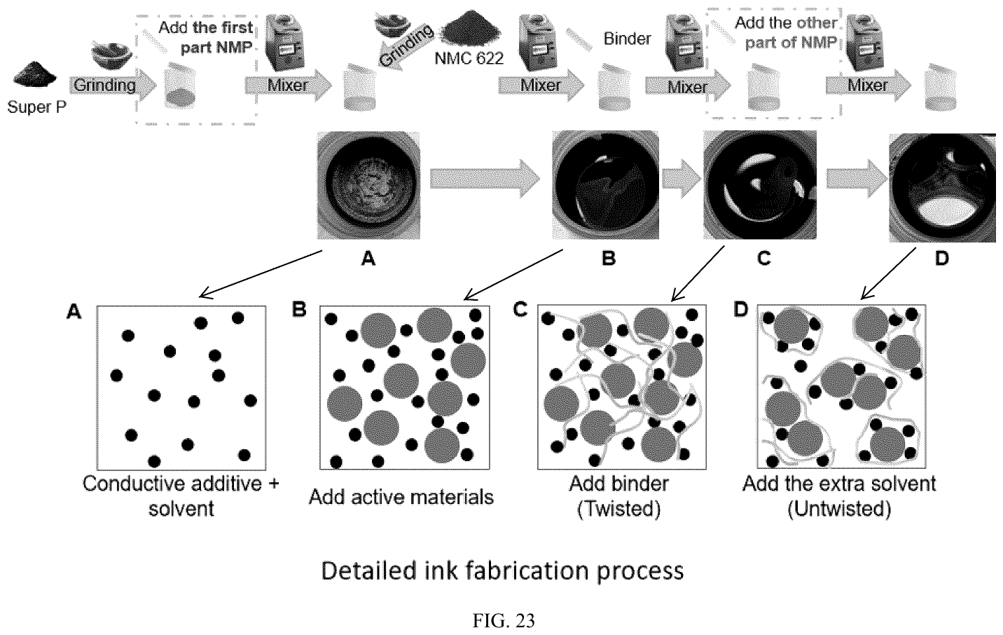

In addition, the viscosity under different shear rates was directly calculated to quantitatively characterize the effects of different methods on the quality of the printing ink. The traditional method of calculating the viscosity, which only applies a flow velocity at the top plane to emerge the velocity gradient between the top and bottom plane. Generally, the expression can be described as where is the viscosity, the thickness normal to the velocity direction, the cross-sectional area, the flow velocity applied at the top, and the force on the top. However, with this traditional method, extracting the force on the top is currently difficult to compute. Here, an alternative, experimentally verified approach (FIG. 22) was used to calculate the viscosity of ink in a rectangular channel[33]. The viscosity is expressed as where is the viscosity, the shear stress, and the shear rate. The simulation setup for the alternative approach can be found in FIG. 16. According to the alternative approach, FIG. 7I shows the viscosity of the inks prepared by the three methods as a function of shear rate. The viscosity is lowest for the M3 ink, followed by the M2 and M1 inks. Generally, viscosity describes the resistance of a fluid to a change in deformation or to the movement of contiguous portions relative to one another; this parameter can also be described as opposition to flow. Therefore, a lower viscosity indicates that less force or energy is required to make a fluid flow. Likewise, forced liquid flow can be easily achieved in lower-viscosity systems by applying the same force or energy. Under the same shear force, the M3 system can easily overcome the resistance during the ink printing process, and particles spread easily due to its lowest viscosity, leading to good printing quality. However, for the M1 system with the highest viscosity, the same shear force is insufficient to overcome the intrinsic deformation resistance and force liquid flow, which makes particle diffusion difficult and leads to worse printing quality. Similarly, the viscosity of the M2 system lies between those of the M1 and M3 systems, and the ability of the applied shear force to induce fluid flow is also in the middle. In addition, from a modeling point of view, the relaxation of the system and the physical force imposed in the last step in M3 can effectively enhance particle dispersion, which can maintain particle flow at faster speeds and lead to a lower viscosity. These findings indicate that M3 can lead to the best quality of printing ink, followed by M2 and M1.

Conclusion. In this work, for the first time, twisted molecular chains of the binder were opened in the printing ink to achieve both excellent printability and improved battery performance. Considering that the internal architectural continuity and component distribution of printed electrodes determine their electrochemical performance, an innovative scalable ink preparation process—a two-step approach of dropwise adding solvent to open the twisted molecular chains and ensure the distribution of components within inks—was developed. A screen-printable LiNi_{0.6}Mn_{0.2}Co_{0.2}O₂ cathode ink with ultrahigh (60%) solid content was prepared using the two-step approach. The screen-printed electrode exhibited a higher charge capacity of 141 mAh/g at 6 C than the electrode with a suboptimal carbon distribution (110 mAh/g) and the electrode with weak continuity of internal electrode structure and inhomogeneous binder distribution (106 mAh/g). Moreover, the screen-printed electrode fabricated by the two-step approach had adequate stability at 1 C (capacity retention of 81% after 100 cycles), which is much better than the one with poor screen printing quality by utilizing the molecular heavily twisted ink. The results emphasize the relationship between printing quality, internal architecture, and the cycling stability of electrodes. Additionally, the mechanism of the two-step approach was revealed: the first part of the solvent disperses the components, and the second part of the solvent opens the twisted molecular chains. Based on it, the pathways to optimize the ink to fabricate composition homogeneity and internal structure continuity of screen-printed electrodes in various situations was studied. Furthermore, coarse-grained molecular dynamics were employed to study the component distribution within inks and the shear behavior of inks during the printing process, and their fluidity was explored using the lattice Boltzmann method. The proposed straightforward and low-cost ink preparation strategy can be scaled up to manufacture large-scale R2R screen printing and can potentially facilitate research and industrial manufacturing on architecture design for screen-printed electrodes.

### Experimental Section

Materials. The prepared high solid content inks consist of Multi-crystalline NMC 622 (diameter of 3.5 μm from Nanoramic Laboratories), Super P (diameter in 40 nm from MTI Corporation), homopolymer PVDF (Kureha 7200 with an average molecular weight of 6.3*10⁵ g mol⁻¹ and inherent viscosity in 2.1 dl/g purchased from Kureha Company), and NMP (Fisher Science Education) as active material, a conductive additive, binder, and solution, respectively. NMC 622 particle size distribution is shown in FIGS. 18A and 18B. Before the utilization, NMC 622 and Super P were dried under a vacuum oven for at least 12 h, and the PVDF was dissolved into NMP to get a concentration of 10 wt. %. All chemicals and materials were utilized without additional processing.

Ink preparation. The above materials were mixed following the steps shown in FIG. 8 and Table 1. All inks were prepared as NMC 622: Super P: PVDF=94:4:2 in the formulation and 5 g for total weight per batch. Herein, Method 3 is highlighted because of its excellent printability and battery performance of printed electrodes. First, 0.12 g Super P and the first part of NMP were mixed in a plastic cup (20 mm in diameter); following it, 2.82 g NMC 622 were added and mixed; and then, 0.6 g dissolved at 10 wt. % PVDF were added and mixed; finally, the second part of NMP was added and then mixed the whole materials to homogeneous. NMP added a total of 1.46 g. The mixing processes were done by a dual asymmetric centrifugal mechanism (DAC 330-100 Pro Speedmixer from FlakTek). For each mixing process, materials withstood 1500 rpm for 30 seconds, 2500 for 30 seconds, and 3500 rpm for 240 seconds. The variables were controlled by preparing all the inks with the same total mixing time. Although the total NMP was kept, the ratio of NMP added in the first and the second steps were controlled and labeled as 75%-25%, 80%-20%, 85%-15%, and 90%-10%.

Screen printing. The pattern for electrode printing was designed using Adobe Illustrator software (Adobe Inc.), and the pattern dimensions of 4.5 cm×12 cm with circles of 0.5 cm in diameter. The 300 mesh screen were purchased in the market, and the thickness of the total screen and emulsion is around 60 μm for electrode printing. Due to the differences in printability for various inks, adjusting the printing layers has been done to keep the same mass loading (around 6.5 mg/cm²) of printed electrodes for the electrochemical properties evaluations. Specifically, three layers of printing work for electrodes printed with M2 and M3 inks, and six layers of printing works for that with M1 ink. The theoretical density of the as-prepared electrode is 2.66 g/cm³, which is calculated by ρₘᵢₓ=Σρᵢ*Xi, where Xi is the volume fraction of each component. The porosity of M1, M2, and M3 electrodes are 34.8%, 36.5%, and 37.2%, respectively. And the channels distribute as follows: 0.5 mm in channel diameter and 2 mm in edge distance of channels. The double sides carbon-coated Al foil (Suzhou Sineno Technology Co., LTD) is used as both the current collector and substrate to evaluate the electrochemical properties of screen-printed electrodes. However, the black carbon-coated layer makes it difficult to distinguish the printability of inks. An Al foil (MTI Corporation) is used as the substrate to display the printability of inks.

Characterization methods. The morphology of the samples was observed by Hitachi S4800 SEM at 3 kV. The rheological properties were measured by a discovery hybrid rheometer (Discovery HR-30) from TA-Instruments with a flat Peltier plate.

X-ray computed tomography. The XCT measurement was carried out using a Zeiss Xradia Versa 520 XCT unit. The data were obtained over a sample rotation of ω=360° with 1601 projections at equal steps. The data were collected using 4× and 20× scintillator objectives for two separate magnifications. The 4× scans were collected at 40 kV at 3 W, and 20× scans were used at 60 kV at 5 W. The higher power was used at 20× to increase the counts because the scintillator screen was significantly thinner for the 20× scintillator objective. A 2×2 binning was used for optimized resolution and measurement time. The resultant pixel sizes for the 4× and 20× scans were 1.03 μm and 0.65 μm, respectively. An ORS Dragonfly PRO v.3.5 software was used for image processing and segmentation.

Electrochemistry characterization. In all the electrochemical measurements, the electrolyte was 1.2 M LiPF₆ dissolved in EC: EMC=3:7 by weight (Gen). 80 μL of the electrolyte was added to the cell during the assembly. The Celgard 2400 (25 m in thickness) was used as the separator. The active materials mass loading of screen printed electrode was around 6.5 mg/cm². EIS was performed using an electrochemical station (Biologic SP150) in the frequency range of 1 MHz to 100 mHz at room temperature, and cyclic voltammetry (CV) was carried in the range of 2.8 V-4.3 V using Biologic MPG2 in the scan rate of 0.1 mV/s. Galvanostatic tests were performed using a LANDT 8-channel tester (Wuhan LAND Electronic Co., Ltd.). The rate performance was discharged at C/3 and charged at different C-rate, respectively, 0.1 C for six cycles, then 0.5 C, 1 C, 2 C, 4 C, and 6 C for five cycles, respectively, and finally recovered to 0.1 C for another five cycles. All the electrochemical tests were run at room temperature, and active material capacities were reported.

### Computational Model and Method

Model system. To study the influence of three experimental methods on printing ink quality, their shear flow behaviors were qualitatively studied during printing and the viscosity of their equilibrium configurations calculated by using numerical simulations. The three methods simulated by coarse-grained molecular dynamics corresponding to the experiments are described as follows. For method 1 (M1), super P is first evenly distributed in the simulation box. Then, NMC 622 particles are added into the simulation box, keeping both super P and NMC 622 particles distributed evenly in the solvent. After that, binders are placed on the top of the simulation box, making them evenly fill the space left behind. For method 2 (M2), NMC 622 and super P particles are first separately concentrated and then assembled into the simulation box. Next, the binders are added to the top of the simulation box and let them fill the space left behind. For method 3 (M3), super P particles are first evenly distributed in a simulation box accounting for 90% of the volume of the final simulation box (Equivalent to adding 85% solvent). Next, NMC 622 particles are added to the simulation box, keeping both super P and NMC 622 distributed uniformly in the solvent. Then, binders are added to the top of the simulation box, making them evenly fill the space left behind. After that, the simulation box is further relaxed, and an equilibrium simulation is performed by applying a body force to the solvent to let these binders feather off. Ultimately, the equilibrium configurations of the three methods (M1˜M3) are obtained by performing a longtime simulation using the Lattice Boltzmann method (LBM). The simulation box is 10×30×10 μm³, in which periodic boundary conditions are applied in the x and y directions, while the z-direction is bounded by two flat plates.

Fluid model. Lattice Boltzmann method (LBM) is an efficient solver to recover Navier-Stokes equations for fluid flow [34], which has been widely used to solve fluid dynamics at the milliliter scale [35-37]. The density distribution function is the essential quantity of LBM in phase space, which can be employed to determine the density (ρ) and velocity (u) of fluid. Generally. LBM is considered an accurate second-order method in both time and space. The mathematical derivation of LBM, relationships between the two macro variables, ρ, u, and density distribution function, can be found in our previous studies [38]. In this work, a solvent is implicitly considered by using its density and viscosity as inputs. The density and viscosity of NMP solvent are 1.03 g cm⁻³ and 1.89×10⁻³ Pa s, respectively. The lattice spacing of the fluid field is chosen at 0.1 μm.

Coarse-grained models for NMC622, Super P, and binder. To capture the dynamic motion of NMC622, Super P, and Binder, a Large-scale Atomic/Molecular Massively Parallel Simulator (LAMMPS) [39] is employed to perform all simulations. As shown in FIG. 19, the NMC622 is described as a spherical particle. The diameter of NMC622 is 3.5 μm, with a surface area of 38.4845 μm² and a volume of 22.449 μm³ per particle, which corresponds to the experimental measurement. NMC622 is then uniformly discretized into a series of points with a triangular network of 3558 vertices and 7112 elements, similar to our red blood cell model [31]. The mechanical behaviors of the coarse-grained NMC622 spherical particles are dominated by the in-plane stretching and out-of-plane bending. In addition, constraints are applied to keep the area and volume of individual NMC622 spherical particle constant during the simulation. The potential energy function of a single NMC622 particle is expressed as U(xᵢ)=U_{stretching}+U_{bending}+Uₐᵣₑₐ+Uᵥₒₗᵤₘₑ. U_{stretching} is the in-plane stretch resistance of NMC622 particles. U_{bending} is bending resistance. Uₐᵣₑₐ and Uᵥₒₗᵤₘₑ are used to govern the total area and volume conservation, corresponding to the area and volume incompressibility.

The binder is modeled as a polymer chain with unceasingly connected beads. As shown in FIG. 19B, binders are considered as a series of coarse-grained polymer chains where each chain has a length of 22 μm and 147 beads. All beads of the polymer chain are sequentially connected by harmonic springs, where a harmonic bending potential is implemented among three consecutive beads to govern the binder stiffness. The bond stiffness is set high enough to keep the numerical stability and chain inextensibility, and the bond stiffness, kₛₚ, is set high enough. The bending stiffness, k_{b}, is used to ensure the binder stiffness according to their persistent length. Here, according to our previous studies [38], the bending stiffness is set to 50 k_{B}T.

As shown in FIG. 19, Super P is described as a point particle. Each particle has a diameter of 40 nm. In addition to the above potentials, inter-molecular interactions between NMC622 particles are described as the Morse potential [40, 41] with the functional form Uₘₒᵣₛₑ=D₀[e^{-2β(r—r}^{₀}⁾−2e^{-2β(r-r}^{₀}⁾], r<r_{c}. D₀ is the energy well depth; β is the width of the potential well, r is the distance between two particles, r₀ is the equilibrium distance, and r_{c} is the cutoff distance. A short-range and pure repulsive Lennard-Jones potential is also used to prevent overlapping between NMC622 particles. The inter-molecular interactions between super P particles or molecular chains are described as having the same LJ potential. The inter-molecular interaction between NMC 622 particles and super P particles, NMC 622 particles and binders, and super P particles and binders are also described by LJ potential. Our previous work has calibrated all these potential parameters.[38] All these simulations and physical parameters are summarized in Table 2.

TABLE 2
Coarse-grained potential parameters for all particles in
the simulation with their corresponding physical values.

| Parameters | Simulation (LJ unit) | Physical |
|---|---|---|
| Simulation box size (Lₓ × L_{y} × L_{z}) | 40 × 120 × 40 | 10 × 30 × 10 μm |
| Super P (mass/volume fraction) | 2.4%/2.06% | 2.4%/2.06% |
| NMC622 (mass/volume fraction) | 56.40%/33.55% | 56.40%/33.55% |
| Binder (mass/volume fraction) | 1.20%/1.10% | 1.20%/1.10% |
| NMP solvent (mass/volume fraction) | 40%/63.29% | 40%/63.29% |
| Energy scale (k_{B}T) | 1.0519 × 10⁻⁵ | 4.1418 × 10⁻²¹ N m |
| NMC622 diameter (D) | 14.00 | 3.500 × 10⁻⁶ m |
| Chain length of binder (lₚ) | 87.6 | 2.190 × 10⁻⁵ m |
| Equilibrium bond length of binder (l₀) | 0.60 | 1.500 × 10⁻⁷ m |
| Viscosity of fluid (η) | 0.263 | 1.890 × 10⁻³ Pa s |
| Sphere area constant (kₐ) | 7.4921 × 10⁻² | 4.72 × 10⁻⁵ N m⁻¹ |
| Sphere shear modulus (μᵣ) | 1.00 | 6.30 × 10⁻⁴ N m⁻¹ |
| Sphere local area constant (k_{d}) | 3.6667 | 2.31 × 10⁻³ N m⁻¹ |
| Sphere volume constant (kᵥ) | 0.9881 | 2.490 × 10³ N m⁻² |
| Sphere bending constant (k_{b}) | 0.1270 | 5.000 × 10⁻¹⁸ N m |
| Polymer stretching constant (kₛₚ) | 1.00 | 6.30 × 10⁻⁴ N m⁻¹ |
| Polymer bending constant (k_{b}) | 5.259 × 10⁻⁴ | 2.0709 × 10⁻¹⁹ N m⁻¹ |
| Morse energy well width (β) | 0.96 | 3.84 × 10⁶ m⁻¹ |
| Morse energy (D₀) | 3.160 × 10⁻⁶ | 1.2425 × 10⁻²² N m⁻¹ |
| Morse equilibrium distance (r₀) | 2.00 | 5.000 × 10⁻⁷ m |
| Morse cutoff (r_{c}) | 6.00 | 1.500 × 10⁻⁶ m |
| LJ depth of well (∈) | 1.050 × 10⁻⁴ | 4.14 × 10⁻²¹ N m |
| LJ zero potential distance (σ) | 2.00 | 5.000 × 10⁻⁷ m |
| LJ cutoff distance (rₗⱼ) | 2.24 | 5.600 × 10⁻⁷ m |

Coupling scheme. A recently developed package by Ye and co-workers, namely Open FSI [42], is employed to characterize the fluid-structure interaction (FSI) using immersed boundary (IB) method to couple LBM with LAMMPS [43-45]. The fluid lattices and NMC622 particles are described by Eulerian and Lagrangian mesh points, respectively. The Eulerian resolution was 4 mesh points per micrometer in all directions. There were about 14 Eulerian points across one NMC622 diameter, which can sufficiently capture the deformation and motion of NMC [35, 46]. The coupling between Eulerian and Lagrangian mesh points is fulfilled by interpolating their velocities and forces. This coupling scheme has been validated by our previous work [38].

Shear flow behavior and viscosity calculation. Based on the final equilibrium configurations of the three methods, the shear flow behavior of the ink during the process of printing is first described. The shear flow is driven along the y-direction by moving the z-top flat plate with the same y-direction velocities, calculated from the shear rate values with the formula vₜₒₚ=shear rate×channel height. Here, a shear rate of 20 s⁻¹ is employed to represent the experimental measurement during the process of printing. With regard to the viscosity, the traditional method to calculate the viscosity is to implement a flow velocity at the top, which can be expressed as, μ=Fy/Au, where μ is the viscosity, y is the thickness normal to the velocity direction, A is the cross-sectional area, u is the applied flow velocity at the top, and F is the force on the top. However, this traditional method is difficult to extract the force (F) on the top for the current OpenFSI package. Here, an alternative approach (FIG. 18B) is employed to calculate the viscosity in a rectangular channel, which has been verified by experiment and theory [33]. Within this method, the viscosity is written as, μ=τ_{w}/γ_{w}, where μ is the viscosity, τ_{w} is the shear stress related to the pressure and geometry parameters, and γ_{w} is the shear rate associated with the apparent shear rate, volumetric flow, geometry parameters and the empirical model.

To evaluate the viscosity by using the alternative approach, as shown in FIG. 19, the whole channel is divided into three regions along the y direction, named F-region, buffer, and C-region, respectively. In order to generate the Poiseuille flow through the channel, a driving constant pressure gradient across the channel is exerted on the system by applying a driving force on particles in F-region. A more significant force corresponds to a greater pressure gradient. The exerted lateral force,[47-49] to the particles is proportional to pressure drop as described by ΔP∝NF/A, where ΔP is the pressure drop, A is the cross-sectional area perpendicular to the applied force, and N is the number of particles at the inlet region calculating at each time step and averaging over the total simulation time. The effect of pressure gradient on transport behavior is examined by changing the force range from 1.602×10⁻¹¹ to 6.408×10⁻⁹ N. All simulations are performed to simulate mass transport for 4 s, which is long enough to obtain a steady-state flow, and all calculations are executed in the C-region. All snapshots derived from the simulations are rendered using Visual Molecular Dynamics (VMD) software [50].

### REFERENCES

[1]. Liu, Y., Y. Zhu, and Y. Cui, Challenges and opportunities towards fast-charging battery materials. Nature Energy, 2019. 4(7): p. 540-550.
[2]. Chen, H., et al., Tortuosity effects in lithium-metal host anodes. Joule, 2020. 4(4): p. 938-952.
[3]. Singh, D.P., et al., Facile Micro Templating LifePO4 Electrodes for High Performance Li-Ion Batteries. Advanced Energy Materials, 2013. 3(5): p. 572-578.
[4]. Xiong, R., et al., Scalable Manufacture of High-Performance Battery Electrodes Enabled by a Template-Free Method. Small Methods, 2021. 5(6): p. 2100280.
[5]. Billaud, J., et al., Magnetically aligned graphite electrodes for high-rate performance Li-ion batteries. Nature Energy, 2016. 1(8): p. 1-6.
[6]. Sander, J., et al., High-performance battery electrodes via magnetic templating. Nature Energy, 2016. 1(8): p. 1-7.
[7] Bae, C.J., et al., Design of battery electrodes with dual-scale porosity to minimize tortuosity and maximize performance. Advanced materials, 2013. 25(9): p. 1254-1258.
[8]. Behr, S., et al. Highly-structured, additive-free lithium-ion cathodes by freeze-casting technology. in Ceram. forum int. 2015.
[9]. Lu, L.L., et al., Wood-inspired high-performance ultrathick bulk battery electrodes. Advanced Materials, 2018. 30(20): p. 1706745.
[10]. Shi, B., et al., Low tortuous, highly conductive, and high-areal-capacity battery electrodes enabled by through-thickness aligned carbon fiber framework. Nano letters, 2020. 20(7): p. 5504-5512.
[11]. Liu, Y., et al., Architecturing hierarchical function layers on self-assembled viral templates as 3D) nano-array electrodes for integrated Li-ion microbatteries. Nano Letters, 2013. 13(1): p. 293-300.
[12]. Wang, Z., et al., Development of MnO2 cathode inks for flexographically printed rechargeable zinc-based battery. Journal of Power Sources, 2014. 268: p. 246-254.
[13]. Wang, Y., et al., Large-Scale Manufacturing of Pattern-Integrated Paper Li-Ion Microbatteries through Roll-to-Roll Flexographic Printing. Advanced Materials Technologies: p. 2200303.
[14]. Vollmann, H.W., New technologies for the filmless manufacture of printing forms. Angewandte Chemie International Edition in English, 1980. 19(2): p. 99-110.
[15]. Costa, C., R. Gonçalves, and S. Lanceros-Méndez, Recent advances and future challenges in printed batteries. Energy Storage Materials, 2020. 28: p. 216-234.
[16]. Zhang, X., et al., Extending cycling life of lithium-oxygen batteries based on novel catalytic nanofiber membrane and controllable screen-printed method. Journal of Materials Chemistry A, 2018. 6(43): p. 21458-21467.
[17]. Syrový, T., et al., Cathode material for lithium ion accumulators prepared by screen printing for Smart Textile applications. Journal of Power Sources, 2016. 309: p. 192-201.
[18]. El Baradai, O., et al., Use of cellulose nanofibers as an electrode binder for lithium ion battery screen printing on a paper separator. Nanomaterials, 2018. 8(12): p. 982.
[19]. Sousa, R., et al., High performance screen printable lithium-ion battery cathode ink based on C-LiFePO4. Electrochimica Acta, 2016. 196: p. 92-100.
[20]. Gören, A., et al., High performance screen-printed electrodes prepared by a green solvent approach for lithium-ion batteries. Journal of Power Sources, 2016. 334: p. 65-77.
[21]. Liu, Y., et al., Current and future lithium-ion battery manufacturing. Iscience, 2021: p. 102332.
[22]. Hsu, C.P., et al., effect of polymer binders in screen printing technique of silver pastes. Journal of polymer research, 2013. 20(10): p. 1-8.
[23]. Hatala, M., et al., The effect of the ink composition on the performance of carbon-based conductive screen printing inks. Journal of Materials Science: Materials in Electronics, 2019. 30(2): p. 1034-1044.
[24]. Somalu, M.R., et al., Screen-printing inks for the fabrication of solid oxide fuel cell films: a review. Renewable and Sustainable Energy Reviews, 2017. 75: p. 426-439.
[25]. Marani, D., et al., Influence of hydroxyl content of binders on rheological properties of cerium-gadolinium oxide (CGO) screen printing inks. Journal of the European Ceramic Society, 2015. 35(5): p. 1495-1504.
[26]. Zou, F. and A. Manthiram, A Review of the Design of Advanced Binders for High-Performance Batteries. Advanced Energy Materials, 2020. 10(45): p. 2002508.
[27]. Zhang, Y., et al., Ink formulation, scalable applications and challenging perspectives of screen printing for emerging printed microelectronics. Journal of Energy Chemistry, 2021.
[28]. Hu, G., et al., Functional inks and printing of two-dimensional materials. Chemical Society Reviews, 2018. 47(9): p. 3265-3300.
[29]. Cao, D., et al., Amphipathic Binder Integrating Ultrathin and Highly Ion-Conductive Sulfide Membrane for Cell-Level High-Energy-Density All-Solid-State Batteries. Advanced Materials, 2021: p. 2105505.
[30]. Wang, Q., et al., Origin of structural evolution in capacity degradation for overcharged NMC 622 via operando coupled investigation. ACS applied materials & interfaces, 2017. 9(29): p. 24731-24742.
[31]. Ye, H., Z. Shen, and Y. Li, Computational modeling of magnetic particle margination within blood flow through LAMMPS. Computational Mechanics, 2018. 62(3): p. 457-476.
[32]. Ye, H., Z. Shen, and Y. Li, Interplay of deformability and adhesion on localization of elastic micro-particles in blood flow. Journal of Fluid Mechanics, 2019. 861: p. 55-87.
[33]. Son, Y., Determination of shear viscosity and shear rate from pressure drop and flow rate relationship in a rectangular channel. Polymer, 2007. 48(2): p. 632-637.
[34]. Chen, S. and G.D. Doolen, LATTICE BOLTZMANN METHOD FOR FLUID FLOWS. Annual Review of Fluid Mechanics, 1998. 30(1): p. 329-364.
[35]. MacMeccan, R.M., et al., Simulating deformable particle suspensions using a coupled lattice-Boltzmann and finite-element method. Journal of Fluid Mechanics, 2009. 618: p. 13-39.
[36]. Ye, H., et al., Dynamics of a nonspherical capsule in general flow. Computers & Fluids, 2016. 134-135: p. 31-40.
[37]. Zhang, J., P.C. Johnson, and A.S. Popel, Red blood cell aggregation and dissociation in shear flows simulated by lattice Boltzmann method. Journal of Biomechanics, 2008. 41(1): p. 47-55.
[38]. Ye, H., et al., Anomalous Vascular Dynamics of Nanoworms within Blood Flow. ACS Biomaterials Science & Engineering, 2018. 4(1): p. 66-77.
[39]. Plimpton, S., Fast Parallel Algorithms for Short-Range Molecular Dynamics. Journal of Computational Physics, 1995. 117(1): p. 1-19.
[40]. Fedosov, D.A., et al., Predicting human blood viscosity in silico. Proceedings of the National Academy of Sciences, 2011. 108(29): p. 11772.
[41]. Tan, J., A. Thomas, and Y. Liu, Influence of red blood cells on nanoparticle targeted delivery in microcirculation. Soft Matter, 2012. 8(6): p. 1934-1946.
[42]. Ye, H., et al., OpenFSI: A highly efficient and portable fluid structure simulation package based on immersed-boundary method. Computer Physics Communications, 2020. 256: p. 107463.
[43]. Krüger, T., F. Varnik, and D. Raabe, Efficient and accurate simulations of deformable particles immersed in a fluid using a combined immersed boundary lattice Boltzmann finite element method. Computers & Mathematics with Applications, 2011. 61(12): p. 3485-3505.
[44]. Peskin, C.S., The immersed boundary method. Acta Numerica, 2003. 11: p. 479-517.
[45]. Ye, H., et al., Two tandem flexible loops in a viscous flow. Physics of Fluids, 2017. 29(2): p. 021902.
[46]. Vahidkhah, K. and P. Bagchi, Microparticle Shape Effects on Margination, Near-Wall Dynamics and Adhesion in Three-dimensional Simulation of Red Blood Cell Suspension. Soft Matter, 2015. 11.
[47]. Zhu, F., E. Tajkhorshid, and K. Schulten, Pressure-Induced Water Transport in Membrane Channels Studied by Molecular Dynamics. Biophysical Journal, 2002. 83(1): p. 154-160.
[48]. Kazemi, M. and A. Takbiri-Borujeni, Non-equilibrium molecular dynamics simulation of gas flow in organic nanochannels. Journal of Natural Gas Science and Engineering, 2016. 33: p. 1087-1094.
[49]. Carr, R., et al., Modeling Pressure-Driven Transport of Proteins through a Nanochannel. IEEE transactions on nanotechnology, 2011. 10(1): p. 75-82.
[50]. Humphrey, W., A. Dalke, and K. Schulten, VMD: Visual molecular dynamics. Journal of Molecular Graphics, 1996. 14(1): p. 33-38.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments.

What is claimed is:

1. A screen-printable electrode battery ink, comprising:
a slurry of an active ingredient, conductive additive, a binder, and a solvent, the slurry having a of solids content from about 40% by weight to about 70% by weight that is uniformly distributed in the solvent, wherein the ink has a thixotropic recovery rate from about 30 seconds to about 90 seconds, and wherein the binder has untwisted molecular chains.

2. The ink of claim 1, wherein the active ingredient is LiNi_{0.6}Mn_{0.2}Co_{0.2}O₂ (NMC622), LiNi_{0.8}Mn_{0.1}Co_{0.1}O₂ (NMC 811), LiNi_{0.95}Mn_{0.025}Co_{0.025}O₂, LiFePO₄, graphite, Li₄Ti₅O₁₂, or silicon containing compounds.

3. The ink of claim 1, wherein the conductive additive is carbon black powder, carbon fiber, carbon nanotubes, or graphene.

4. The ink of claim 1, wherein the binder is polyvinylidene fluoride (PVDF), carboxymethyl cellulose (CMC), styrene butadiene rubber (SBR), polytetrafluoroethylene (PTFE), polyacrylic acid (PAA), alginate, or any combination of the binders including CMC and SBR.

5. The ink of claim 1, wherein the solvent is 1-methyl-2-pyrrolidone (NMP), dimethylformamide (DMF), or water.

6. A screen-printed electrode comprising an electrode that is screen-printed with the ink of claim 1.

7. The screen-printed electrode of claim 6, wherein the ink is printed on the electrode in one layer.

8. The screen-printed electrode of claim 6, wherein the ink is printed on the electrode in multiple layers.

9. The screen-printed electrode of claim 6, wherein the electrode has a capacity retention of at least about 80% after 100 cycles at 1 C.

10. The screen-printed electrode of claim 6, wherein the electrode has a Coulombic efficiency of at least about 85%.

11. The screen-printed electrode of claim 8, wherein the electrode has a charge of at least about 140 mAh/g.

12. The screen-printed electrode of claim 6, wherein the electrode comprises high resolution printed patterns of the ink.

13. A fast-charging battery comprising a screen-printed electrode battery of claim 6.

14. An electronic device comprising the fast-charging battery of claim 13.

15. An electric vehicle comprising the fast-charging battery of claim 14.

16. A wearable electronic device comprising the screen-printed electrode battery of claim 6.

17. A method for preparing a screen-printable electrode battery ink, the method comprising:
a) adding a first amount of a solvent to a slurry comprising a conductive additive, an active ingredient, and a binder, and mixing to disperse components of the slurry in the solvent; and
b) adding a second amount of the solvent to the dispersed slurry of (a) and mixing the solvent and the slurry to form the ink having a uniform distribution of components in the solvent;
wherein the solvent is added in two unequal parts with the greater amount being added in (a), to produce an ink having a solids content from about 40% by weight to about 70% by weight, and a thixotropic recovery rate from about 30 seconds to about 90 seconds, and wherein the binder has untwisted molecular chains.

18. The method of claim 17, wherein the amount of solvent added to (a) is from about 70% to about 95% of the total solvent added to the ink.

19. The method of claim 17, wherein the active ingredient is LiNi_{0.6}Mn_{0.2}Co_{0.2}O₂ (NMC622), the conductive additive is carbon black, the binder is polyvinylidene fluoride (PVDF), and the solvent is 1-methyl-2-pyrrolidone (NMP).
